(19) United States
(12) Patent Application Publication
(10) Pub. No.: US 2009/0126640 A1
(43) Pub. Date: May 21, 2009

(54) APPARATUS AND SYSTEM FOR MONITORING THE INTAKE OF FOOD BY ANIMALS

(75) Inventors: Edward A. Ulman, New Brunswick, NJ (US); Jaroslaw Kockanek, North Brunswick, NJ (US); Douglas S. Compton, Glen Gardner, NJ (US); Matthew R. Williams, Lansdale, PA (US)

Correspondence Address: RATNERPRESTIA, P.O. BOX 980, VALLEY FORGE, PA, 19482, US

(73) Assignee: RESEARCH DIETS, INC., New Brunswick, NJ (US)

(21) Appl. No.: 11/817,775

(22) PCT Filed: Mar. 3, 2006
(86) PCT No.: PCT/US06/07606

§ 371 Date: Jun. 17, 2008

Related U.S. Application Data
(60) Provisional application No. 60/658,818, filed on Mar. 4, 2005.

(51) Int. Cl. A01K 1/10; A01K 7/06; G06F 3/00; G06F 17/30; G08B 23/00

(52) U.S. Cl. 119/54; 119/52.1; 119/72; 715/700; 707/104.1; 340/573.3; 707/E17.044

(57) ABSTRACT

An animal feeder comprising a hopper for storing pieces of food is provided. The hopper includes an opening and a gate movable with respect to the hopper between an open position rendering the opening at least partially accessible to an animal and a closed position at least partially preventing access to the opening by an animal. A switch is coupled for activation by movement of the gate.

This Application is a U.S. National Phase Application of PCT International Application PCT/US2006/007606 which claims priority based on U.S. Provisional Application 60/658,818, filed Mar. 4, 2005.

### BACKGROUND OF THE INVENTION

Most biological values measured in laboratory animals respond to qualitative and quantitative variations in food intake. Therefore, methods to assess and vary food quality and quantity are important to all biological researchers, especially to nutrition biologists. For example, measuring and evaluating the ingestive behavior of laboratory animals is important in the study of animal behavior, metabolism, and perturbations thereof due to disease or therapeutic intervention.

It has been recognized, however, that the presence of human interaction during the assessment of ingestive behavior may introduce error to the assessment through disturbance to the animal's native behavior. Accordingly, systems have been proposed for feeding and monitoring laboratory animals in such a way as to reduce the disturbance of the animal's native behavior.

For example, U.S. Pat. No. 6,748,898 to Ulman et al., the disclosure of which is incorporated herein by reference in its entirety, discloses an animal feeder, a feeder mount, a feeder monitor, and a feeder monitoring network. Specifically, the system disclosed in U.S. Pat. No. 6,748,898 may include (1) a spill-proof food hopper, which does not limit or interfere with the natural food intake of ad libitum fed animals; (2) a hardware and software system to continuously monitor the weight of this hopper, detecting and recording the time, duration and amount of each meal; (3) a gate system to restrict food intake by time, amount, or both; and (4) a means to do this for one, tens or hundreds of animals coincidentally.

Although the system disclosed in U.S. Pat. No. 6,748,898 represents a significant improvement over prior systems, there remains a need for improved systems for monitoring the intake of food by animals.

### SUMMARY OF THE INVENTION

According to one aspect of the invention, an animal feeder comprising a hopper for storing pieces of food is provided. The hopper includes an opening and a gate movable with respect to the hopper between an open position rendering the opening at least partially accessible to an animal and a closed position at least partially preventing access to the opening by an animal. A switch is coupled for activation such as by movement of the gate. The animal feeder optionally includes one or more of the following features: activation of the switch by an animal signals a motivation of the animal to eat food stored in the hopper; the switch is activated by pushing or pulling of the gate by the animal; the feeder is configured to open the gate after an animal activates the switch by contacting the gate; the feeder is configured to open the gate after an animal contacts the gate a pre-determined number of times; a cam is coupled to the gate and an arm is coupled to the switch, wherein the cam moves with respect to the arm; and/or the switch may be a vibration sensor, an accelerometer, a displacement switch, a light beam switch or other detector.

According to another aspect of the invention, an animal feeder comprises a screen coupled to the hopper to retain food within the hopper and to provide access by an animal to the food. The animal feeder optionally includes one or more of the following features: the screen is positioned at least partially within the hopper in such a way as to contain food within the hopper while permitting access to the food by an animal; a mesh is engaged by a surface of the screen; the mesh is releasably engaged with respect to the screen so that it can be removed and replaced; the mesh is formed from at least one wire; elongated runs of the wire run in a substantially horizontal direction; elongated runs of the wire run in a substantially vertical direction; the wire is rounded or has a circular cross-sectional shape; the screen is metallic; the screen is a one-piece component; the screen includes at least one flange to facilitate interconnection of the screen and a surface of the hopper; the screen comprises a plurality of formed wires coupled to opposing headers; the opposing headers are configured to engage or snap onto the hopper; the screen is shaped to allow an animal access to contained food from at least one of the top, side or bottom of the hopper; and/or the screen defines openings that are larger than an animal muzzle but smaller than pellets of the food.

According to yet another aspect of the invention, an animal feeder comprises a reservoir defined by the hopper for storing a liquid. A valve is configured to permit selective flow of liquid from the reservoir. The animal feeder optionally includes one or more of the following features: means are provided for transmitting the weight of liquid contained within the hopper; a top end of the reservoir is open to the atmosphere; the reservoir is defined by a body portion of the hopper; the valve is coupled to the body portion of the hopper; the valve comprises a valve housing and a nipple mounted for movement with respect to the valve housing to permit selective flow of liquid from the reservoir; the nipple is spring loaded; an seal is positioned to provide a selective seal between the nipple and the valve housing; the seal closes an interface between the nipple and the valve housing in a closed position of the valve; a recess is defined in the body portion of the hopper to provide at least partial clearance for the head of the laboratory animal; and/or the recess comprises a sloped wall disposed to capture unconsumed liquid released from the reservoir.

According to still another aspect of the invention, an animal feeder comprises a gate movable with respect to the hopper between an open position rendering the opening at least partially accessible to an animal and a closed position at least partially preventing access to the opening by an animal, the gate being pivotable to rotate between the open and closed positions. The animal feeder optionally includes one or more of the following features: a cam is coupled to the gate; an arm is connected to a servo, wherein the cam moves with respect to the arm; the cam is mechanically grounded against the arm in the closed position of the gate; the servo is configured to be deactivated in one or more positions of the gate; the gate and servo are configured to maintain one or more positions when the servo is deactivated; the gate is configured to be captured in a pre-selected position; a surface is associated with the cam or the gate to capture the gate in a pre-selected position; the gate is biased toward a desired position under the force of gravity; and/or the gate is pivotable about a shaft to rotate between the open and closed positions.

According to another aspect of the invention, a method of communicating feeding activity of an animal is provided. The method comprises the steps of storing data corresponding to individual feeding bouts and displaying the individual feeding bouts. The method optionally includes one or more of the following steps: a displaying step comprising displaying the individual feeding bouts in a graphical user interface (GUI); a step of storing data corresponding to a cumulative feeding bout; a step of storing cumulative feeding bout data of at least one group of animals, wherein at least one animal is a member of a group of animals; a step of calculating an average cumulative feeding bout of a group of animals; a step of displaying the average cumulative feeding bout of a group of animals; a step of resetting the cumulative feeding bout measurement to a pre-determined value in the event of a change in an environmental condition; a step of resetting the cumulative feeding bout measurement to a pre-determined value after a pre-determined time interval; a step of displaying the cumulative feeding bout; steps of displaying the individual feeding bouts and displaying an environmental condition with respect to time; a step of filtering individual feeding bout data in a specified data range; a step of displaying the individual feeding bout within the specified data range; and/or a step of displaying the individual feeding bout outside of the specified data range.

According to still another aspect of the invention, a method of monitoring feeding activity of an animal is provided. The method comprises the steps of communicating data corresponding to individual feeding bouts to a remote location and displaying the individual feeding bouts at the remote location. The method optionally includes one or more of the following steps: a step of communicating data corresponding to individual feeding bouts of multiple animals to a remote location; and/or a step of communicating the data over a network.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1A is a partial end view of an exemplary embodiment of an animal cage according to an aspect of this invention.

FIG. 1B is a partial cross-sectional side view of the animal cage shown in FIG. 1A.

FIG. 2A is a front view of an exemplary embodiment of a molding component configured for use in an animal cage according to an aspect of this invention.

FIG. 2B is a side view of the molding component shown in FIG. 2A.

FIG. 2C is a top view of the molding component shown in FIG. 2A.

FIG. 3A is a partial cross-sectional side view of an embodiment of an adapter assembly according to an aspect of this invention.

FIG. 3B is a cross-sectional opposite side view of the adapter assembly shown in FIG. 3A.

FIG. 3C is a partial cross-sectional rear view of the adapter assembly shown in FIG. 3A, with a hopper assembly of the adapter assembly removed to reveal additional features.

FIG. 3D is a partial cross-sectional top view of the adapter assembly shown in FIG. 3A, with the hopper assembly and other components of the adapter assembly removed to reveal additional features.

FIG. 3E is a partial cross-sectional bottom view of the adapter assembly shown in FIG. 3A, with a plate component of the adapter assembly removed to reveal additional features.

FIG. 3F is an enlarged bottom view of a portion of the adapter assembly shown in FIG. 3E.

FIG. 3G provides cross-sectional side and front views of an embodiment of a hopper component configured for use in the adapter assembly shown in FIG. 3A.

FIG. 3H provides cross-sectional side and front views of another embodiment of a hopper component configured for use in the adapter assembly shown in FIG. 3A.

FIG. 3I is a partial end view of an exemplary embodiment of an animal cage and an adapter assembly according to an aspect of this invention.

FIG. 3J is a partial cross-sectional side view of the animal cage and the adapter assembly shown in FIG. 3I.

FIG. 3K is a partial cross-sectional side view of an embodiment of an adapter assembly according to another aspect of this invention.

FIG. 4A is a cross-sectional side view of an embodiment of a hopper assembly configured for use in the adapter assembly shown in FIG. 3A.

FIG. 4B is a front view of the hopper assembly shown in FIG. 4A.

FIG. 4C is a bottom view of the hopper assembly shown in FIG. 4A.

FIG. 5A is a cross-sectional side view of an embodiment of a screen component configured for use in the hopper assembly shown in FIG. 4A.

FIG. 5B is a front view of the screen component shown in FIG. 5A.

FIG. 5C is a top view of the screen component shown in FIG. 5A.

FIG. 5D is an enlarged cross-sectional side view of the screen component shown in FIG. 5A.

FIG. 6 is a front view of an embodiment of a mesh component configured for use with the screen component shown in FIG. 5A.

FIG. 7 is a front view of another embodiment of a mesh component configured for use with the screen component shown in FIG. 5A.

FIG. 8A is a side view of a support component configured for use in the hopper assembly shown in FIG. 4A.

FIG. 8B is a bottom view of the support component shown in FIG. 8A.

FIG. 9A is a cross-sectional side view of another embodiment of a screen component configured for use in the hopper assembly shown in FIG. 4A.

FIG. 9B is a front view of the screen component shown in FIG. 9A.

FIG. 9C is a top view of the screen component shown in FIG. 9A.

FIG. 10A is a partial cross-sectional front view of an adapter component configured for use in the adapter assembly shown in FIG. 3A.

FIG. 10B is a side view of the adapter component shown in FIG. 10A.

FIG. 10C is a cross-sectional opposite side view of the adapter component shown in FIG. 10A.

FIG. 10D is a partial cross-sectional top view of the adapter component shown in FIG. 10A.

FIG. 10E is a bottom view of the adapter component shown in FIG. 10A.

FIG. 11A is a side view of an embodiment of a hook component configured for use in the adapter assembly shown in FIG. 3A.

FIG. 11B is a top view of the hook component shown in FIG. 11A.

FIG. 11C is a front view of the hook component shown in FIG. 11A.

FIG. 12 is a side view of an embodiment of a clip component configured for use in the adapter assembly shown in FIG. 3A.

FIG. 13A is a front view of an embodiment of a gate component configured for use in the adapter assembly shown in FIG. 3A.

FIG. 13B is a side view of the gate component shown in FIG. 13A.

FIG. 13C is an end view of the gate component shown in FIG. 13A.

FIG. 14A is a front view of an embodiment of a bracket component configured for use in the adapter assembly shown in FIG. 3A.

FIG. 14B is a cross-sectional side view of the bracket component shown in FIG. 14A.

FIG. 14C is a top view of the bracket component shown in FIG. 14A.

FIG. 15A is a partial cross-sectional side view of an embodiment of a coupling component configured for use in the adapter assembly shown in FIG. 3A.

FIG. 15B is an end view of another embodiment of a coupling component configured for use in the adapter assembly shown in FIG. 3A.

FIG. 15C is a cross-sectional side view of the coupling component shown in FIG. 15B.

FIG. 16 is a cross-sectional side view of an embodiment of a cam component configured for use in the adapter assembly shown in FIG. 3A.

FIG. 17A is a front view of an embodiment of a blocker assembly configured for use with the animal cage shown in FIG. 19A.

FIG. 17B is a cross-sectional side view of the blocker assembly shown in FIG. 17A.

FIG. 18 is a cross-sectional opposite side view of another embodiment of an adapter assembly.

FIG. 19A is a side view of the bracket configured for use in the hopper assembly shown in FIG. 18.

FIG. 19B is a top view of the bracket shown in FIG. 19A.

FIG. 20A is a side view of the screen component configured for use in the hopper assembly shown in FIG. 18.

FIG. 20B is a front view of the screen component shown in FIG. 20A.

FIG. 21 is a cross-sectional opposite side view of another embodiment of an adapter assembly including a water hopper assembly.

FIG. 22A is a cross-sectional side view of the water hopper configured for use in the adapter assembly shown in FIG. 21.

FIG. 22B is a top view of the water hopper shown in FIG. 22A.

FIG. 22C is a perspective view of the water hopper shown in FIG. 22A.

FIG. 23 is a single screen view of an exemplary ‘Startup’ graphical user interface (GUI) of the BioDAQ software tool.

FIG. 24 is a single screen view of an exemplary Network Population GUI of the BioDAQ software tool.

FIG. 25 is a single screen view of an exemplary Measurement Parameter Setting GUI of the BioDAQ software tool.

FIG. 26 is a single screen view of an exemplary Food Intake Recordation GUI of the BioDAQ software tool.

FIG. 27 is a single screen view of an exemplary Cell Calibration GUI of the BioDAQ software tool.

FIG. 28 is a single screen view of an exemplary Measurement Assessment GUI of the BioDAQ software tool.

FIG. 29 is a single screen view of an exemplary Data Viewer GUI of the BioDAQ software tool, illustrating the average cumulative food consumption of two groups of laboratory animals with respect to room lighting and time.

FIG. 30 is another single screen view of the exemplary Data Viewer GUI shown in FIG. 29, illustrating the cumulative food consumption of each laboratory animal included in the experiment with respect to room lighting and time.

FIG. 31 is another single screen view of the exemplary Data Viewer GUI shown in FIG. 29, illustrating the cumulative food consumption and individual feeding bouts of one laboratory animal with respect to room lighting and time.

FIG. 32 is another single screen view of the exemplary Data Viewer GUI shown in FIG. 29, illustrating the cumulative food consumption of one laboratory animal with respect to room lighting and time, whereby the cumulative food consumption measurement is reset after each room lighting change.

FIG. 33 is another single screen view of the exemplary Data Viewer GUI shown in FIG. 29, illustrating the cumulative food consumption of one laboratory animal with respect to room temperature and time.

FIG. 34 is a schematic diagram of an exemplary system for monitoring the feeding habits of animals.

FIG. 35 is a schematic diagram of another exemplary system for monitoring the feeding habits of animals.

FIG. 36 is a schematic diagram of yet another exemplary system for monitoring the feeding habits of animals.

### DETAILED DESCRIPTION OF THE INVENTION

The invention is best understood from the following detailed description when read in connection with the accompanying drawing, which shows exemplary embodiments of the invention selected for illustrative purposes. The invention will be illustrated with reference to the Figures. Such Figures are intended to be illustrative rather than limiting and are included herewith to facilitate the explanation of the present invention.

Generally, an ingestive behavior monitor according to exemplary aspects of this invention is comprised of a series of integrated physical and electrical components which quantitatively record ingestive behavior in the substantial absence of human interaction. The system monitors the mass of food sources presented to the animal in its home cage. The system detects interaction between the animal and the food by measuring the stability of the mass measurement. As the animal interacts with the device to obtain food, the act of ingestion is detected.

A precision strain gauge is contiguously interfaced mechanically with the food device. The mass is sampled periodically, approximately once per second, to derive a history of the mass. By evaluating this history mathematically, the monitor is able to record the animals' ingestive behavior in a date/time/mass/duration data stream with a resolution of 1 second, for example, through time. The monitor may be installed in an accredited animal room or laboratory used to house research animals for acute or chronic studies. The instrument is designed to impart low impact to the general facility environment. The instrument can withstand the normal procedures used in general day to day maintenance of the colonies housed in the room. Though other materials are contemplated, many components of the food intake monitor device are composed of stainless steel and polycarbonate and can be cleaned using the same procedure used for washing typical animal husbandry equipment.

When used herein, the term “feeding bout” refers to the period when the animal is actually removing food from the hopper; the term “feeding event or meal” refers to the period when the animal is actively eating, generally composed of one or more feeding bouts interspersed with brief periods of rest, chewing, etc.; the term “inter-bout interval” (IBI) refers to the time period that defines the end of a feeding event; the term “trip” refers to the level of activity which indicates that the animal is feeding; and the term “noise” refers to the level of activity which indicates that the hopper mass measurement is unstable and is used to qualify a meal starting or ending mass measurement.

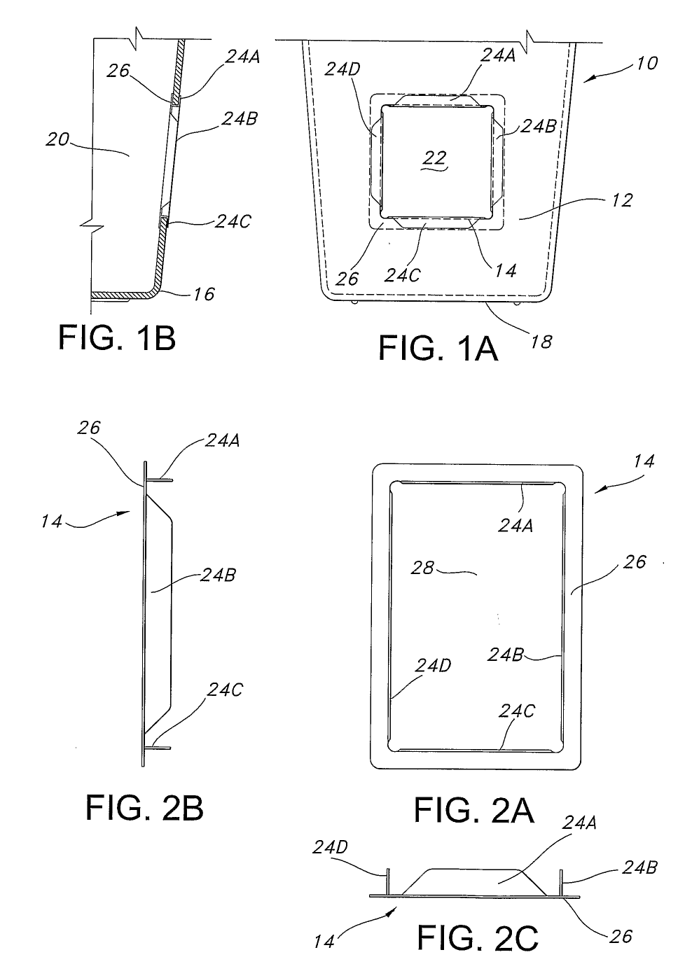

Referring generally to the Figures, one aspect of this invention provides a system for monitoring the intake of food by animals. FIG. 1A provides a partial end view of an exemplary embodiment of an animal cage according to an aspect of this invention, and FIG. 1B is a partial cross-sectional side view of the animal cage shown in FIG. 1A.

According to one embodiment, a molding such as a stainless steel channel is wrapped around an opening in a cage to prevent an animal from chewing the cage material (optionally plastic) and acts as a mounting surface for an adapter assembly. The molding does not significantly alter the dimensions or integrity of the cage and does not prevent a clear view of the animal. Accordingly, the molding provides a secure mounting surface for mechanism connection and covers cage edges to prevent gnawing. Also, multiple mechanisms are easily swapped using the molding (e.g., food monitoring, blank, manual recording, and other mechanisms). Also, the molding facilitates quick exchange of mechanisms.

Referring specifically to the embodiment illustrated in FIGS. 1A and 1B, an animal cage assembly according to one aspect of this invention is generally designated by the numeral 10. Animal cage assembly 10 includes an animal cage 12 and a molding 14. Generally, the animal cage 12 provides an enclosure for an animal such as a laboratory mouse or rat. Animal cage 12 is optionally formed from a plastic material, preferably transparent or translucent, but may be alternatively formed from any of a variety of plastic and non-plastic materials. Exemplary animal cages are currently available from Allentown Caging Equipment Company, Route 526, P.O. Box 698, Allentown, N.J. 08501-0698, and such cages are disclosed in U.S. Pat. No. 5,894,816 to Coiro et al., the disclosure of which is incorporated by reference herein in its entirety.

Animal cage 12 has a side wall 16 and a base 18 that together define an interior 20. Defined in at least one side wall 16 of the animal cage 12 is an aperture 22. The purpose of aperture 22 will be described later in greater detail.

As mentioned previously, the molding 14 is provided to protect the edge surfaces of the side wall 16 of the animal cage 12 that are defined by the aperture 22. Molding 14 also serves to support the side wall 16 of the animal cage 12 in the area of the aperture 22. And as will be described later in greater detail, molding 14 provides a mounting surface by which components or assemblies or mechanisms can be mounted to the animal cage assembly 10.

Molding 14 has a plurality of flanges 24A, 24B, 24C, and 24D. Also, molding 14 has a perimeter 26. As is best illustrated in FIG. 1B, the perimeter 26 of the molding 14 is positioned against an interior surface of the side wall 16 of the animal cage 12 in the area of the aperture 22, with the flanges 24A through 24D extending through the aperture 22 from the interior surface of side wall 16 outwardly beyond an exterior surface of the side wall 16. The flanges 24A through 24D are then bent or otherwise deformed in a direction away from the center of the aperture 22 so that they are positioned against an exterior surface of the side wall 16 of the animal cage 12. The molding 14, so positioned with respect to the aperture 22, thereby forms a frame or edge molding in which the exposed surfaces of the flanges 24A through 24D are exposed yet protect the edges in the side wall 16 of the animal cage 12 defined by the aperture 22. In other words, the flanges 24A through 24D and the perimeter 26 of the molding 14 substantially cover the edge surfaces of the side wall 16 defined by the aperture 22.

The molding 14, as assembled with the animal cage 12 to form the animal cage assembly 10, performs at least three (3) functions. First, molding 14 (by virtue of perimeter 26 and flanges 24A through 24D) substantially prevents an animal within the animal cage assembly 10 from chewing, gnawing, scratching, or otherwise damaging the animal cage 12 in the area of the aperture 22. Second, molding 14 provides a structural support or reinforcement to the side wall 16 of the animal cage 12 in the area of the aperture 22. Third, molding 14 (again by virtue of perimeter 26 and flanges 24A through 24D) provides one or more mounting surfaces by which a component or assembly or mechanism can be mounted to the animal cage 12 in the area of the aperture 22. Other functions of the molding 14 will become evident in view of the following description.

FIGS. 2A, 2B, and 2C are front, side and top views, respectively, of an exemplary embodiment of a frame component configured for use in an animal cage according to an aspect of this invention. The frame or molding component serves as a grommet that is fitted around the aperture in a cage. In addition to the functions recited previously (e.g., providing a secure mounting surface to accept various pieces to be mounted to the cage and covering plastic edges so that plastic can not be gnawed by an animal), the molding component is substantially flat to the cage to allow normal stacking of cages for storage and cleaning. Also, more than one molding component can be added to a cage.

Referring specifically to the embodiment illustrated in FIGS. 2A, 2B, and 2C, the molding 14 is shown before its assembly with the animal cage 12 to form the animal cage assembly 10. Though molding 14 illustrated in FIGS. 2A through 2C differs from that shown in FIGS. 1A and 1B, like numbers have been used to indicate the features of the molding 14 in FIGS. 1A, 1B, 2A, 2B, and 2C.

As illustrated in FIG. 2A, the perimeter 26 of molding 14 defines an interior aperture 28 flanked by flanges 24A through 24D. As shown in FIGS. 2B and 2C, flanges 24A through 24D extend in a direction that is substantially perpendicular to the plane in which the perimeter 26 of the molding 14 resides. This orientation of flanges 24A through 24D is a pre-mounted orientation (i.e., before the flanges 24A through 24D are bent or folded in a radially outward direction in order to engage the molding 14 to the animal cage 12 to form the animal cage assembly 10).

As is exemplified by comparing FIGS. 1A and 1B to FIGS. 2A through 2C, a shape of the molding 14 (as defined by the perimeter 26 and the flanges 24A through 24D) can be selected to match virtually any shape of an aperture formed in the side wall (or any other wall) of an animals cage. In other words, a molding can be configured to conform to an aperture of any shape. Although a four-sided molding 14 is illustrated in FIGS. 1A through 2C, molding 14 can be provided with fewer or a greater number of sides with fewer or a greater number of flanges. Additionally, the shape of the molding can be defined by arcuate geometries such as those of a circle, an oval, an ellipse, or any other configuration.

No matter what shape is selected for the perimeter 26 of the molding 14, one or more flanges can be positioned at various positions along that perimeter in order to engage the molding to an animal cage 12 at the location of an aperture 22. Also, the molding's perimeter need not define an enclosed aperture such as aperture 28 and may instead be open at one end or elsewhere depending on the intended use of the molding and the positioning of an aperture such as aperture 22 in the animal cage 12.

While a wide variety of materials can be selected for the molding 14, a malleable metallic material is preferred. According to one exemplary embodiment, the molding 14 can be formed from a stainless steel material such as 304 stainless steel. Alternatively, other metallic or non-metallic materials can be selected for the molding 14, depending upon the use of the molding and other criteria. Also, the thickness of the material from which the molding 14 is formed is optionally about 0.028 inch, though a wide variety of dimensions can be selected based on the material chosen to form the molding and other criteria. In another embodiment, the flanges of the molding 14 are configured to snap or clip onto the side wall in the area of the aperture 22. It is also anticipated that the molding might be constructed of several pieces and assembled into place, for example with a perimeter piece and one or more flanges that are fastened to the perimeter piece or cage rather than as a single piece that is formed into place.

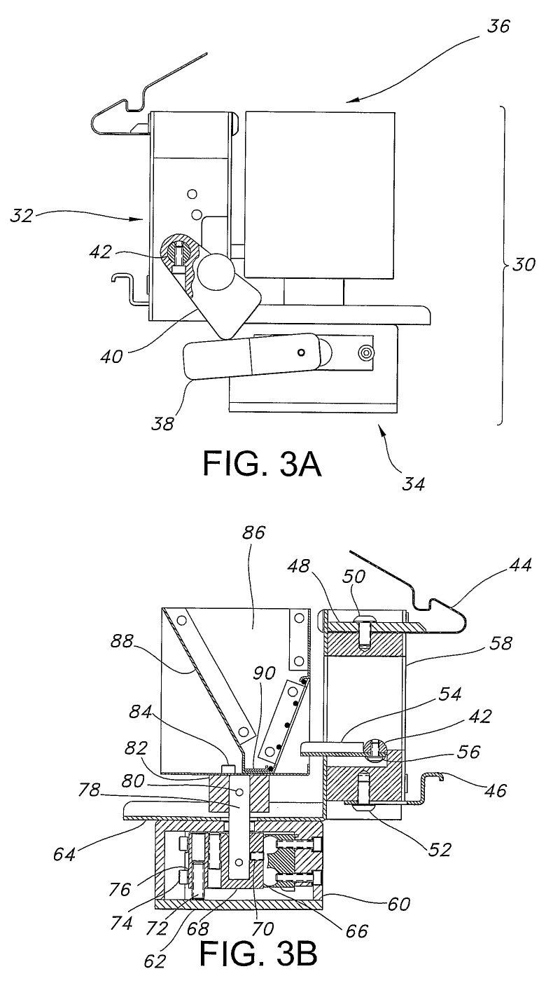

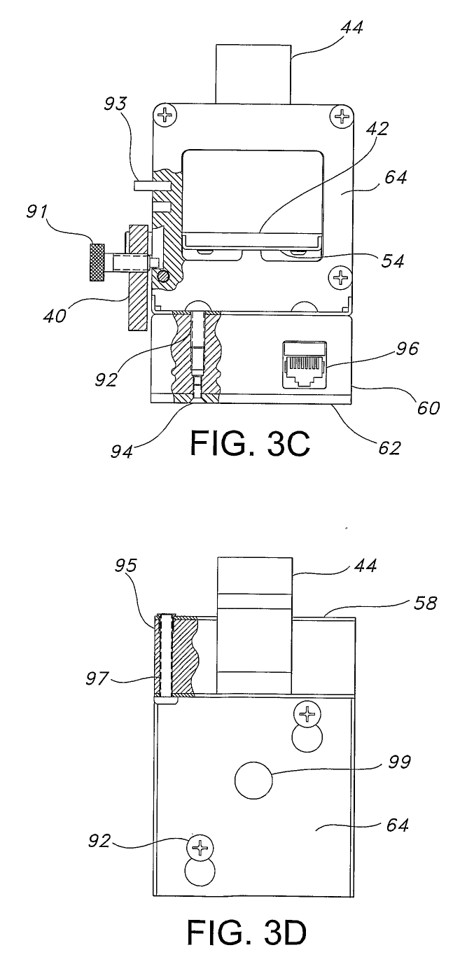

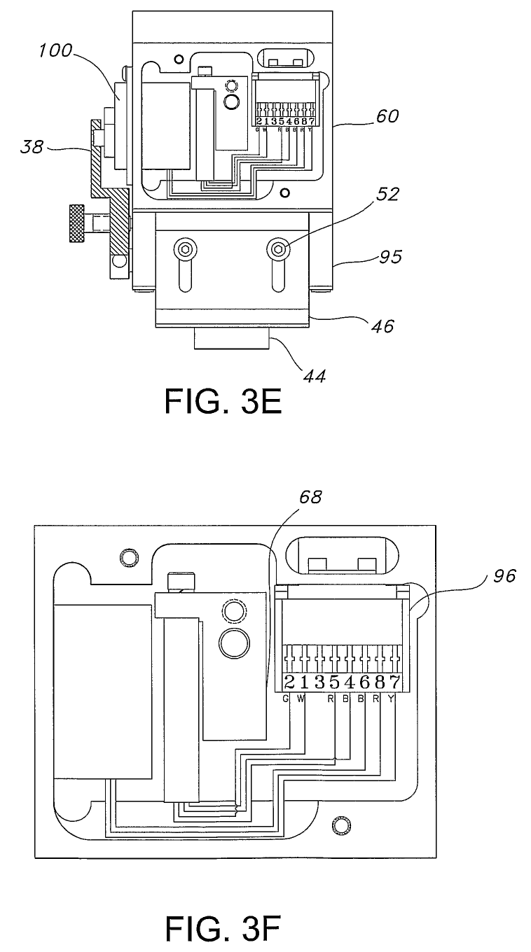

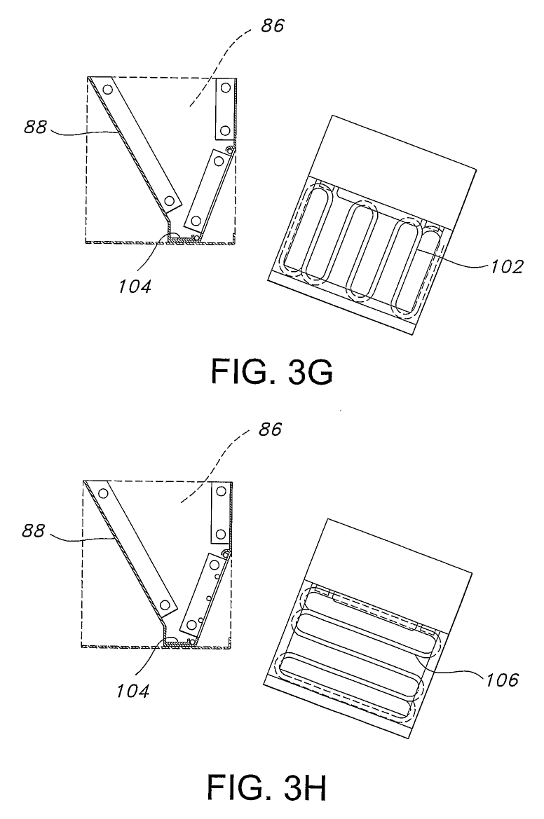

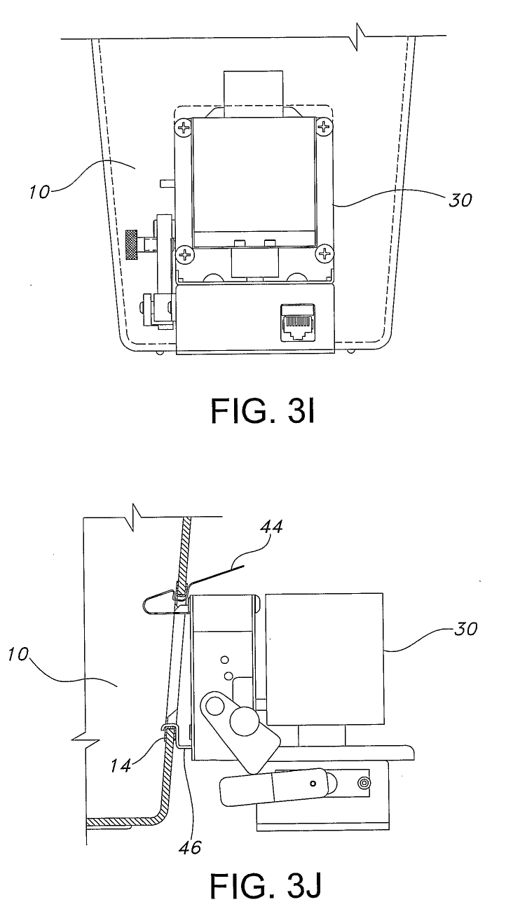

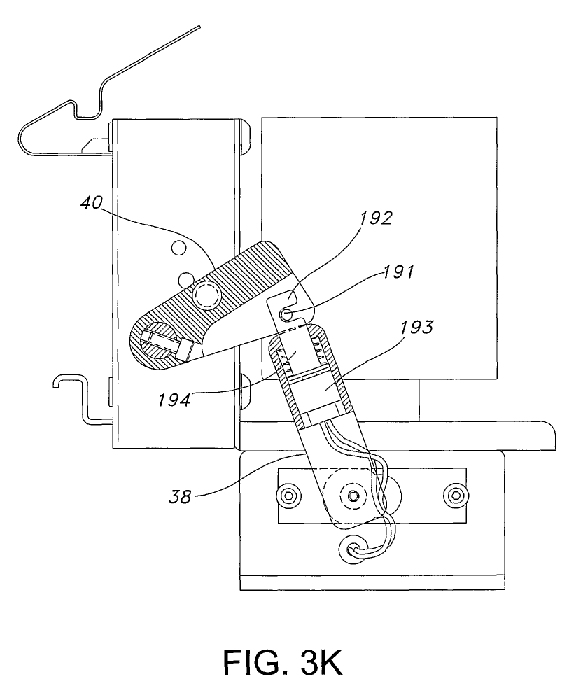

FIGS. 3A through 3K illustrate an embodiment of an adapter assembly that can be releasably engaged to an animal cage assembly according to an aspect of this invention. Generally, the adapter assembly is one example of a mechanism that can be connected to and disconnected from a cage. Preferably, the adapter assembly can be coupled to the cage while it sits on a flat surface without tilting or lifting the cage. One or more adapter assemblies may be releasably engaged to a single animal cage, as desired by the user. The adapter assembly is also referred to below as a Peripheral Control Unit (PSC).

As will be described in greater detail with specific reference to FIGS. 3A through 3K, the adapter assembly includes a load cell enclosure that can take the form of a metal box that mounts on the cage and holds a food hopper. The enclosure houses a load cell, a servo and other devices and is universally fitted to an L-bracket component of the adapter assembly for both rat and mouse hoppers, for example. The load cell enclosure contains a strain gauge and a receptacle such as a sensor cable receptacle. The enclosure has a centrally located hole which allows a post to connect to the food hopper. Fasteners located on the enclosure are used to secure the device to the feeding device.

The adapter assembly (or other part to be mounted) is fitted with several parts, including a clip at the top and a hook near the bottom. The adapter assembly is mounted first by the hook and then engaged in place by the clip. The hook can be adjusted forward and backward to account for the different draft angles possible in different cages that may be offered by different manufacturers. Although not shown, alternate embodiments would allow the clip to be adjusted forward and backward, instead of the hook, to account for different draft angles or have the clip and hook displaced horizontally from the center of the aperture instead of vertically or have the hook at the top and the clip at the bottom. Additionally, although the illustrated embodiment shows a single hook and clip, it is anticipated that some embodiments may use multiple hooks or clips similarly arranged. This mounting mechanism can be used to mount food delivery devices, water delivery devices, exercise equipment or any other device that may be used in connection with laboratory animals.

A coupling allows rapid mounting of a hopper onto the load cell. The coupling optionally has ‘spurs’ or other features configured to substantially resist rotation or torque of the hopper. A cage mount module of the adapter assembly optionally includes a stainless steel L-bracket mounted to a support, such as a polycarbonate block, with an integrated cage mounting clip and a manual gate.

A gate that can be automatically controlled by the system is preferably provided with a pivoting action that pushes the animal away from the opening of the hopper containing food. When the gate is open (e.g., down) the gate can be positioned to lock the hopper in place, thereby capturing the hopper without bolting it. The gate of the adapter assembly is controlled by a cam and an arm attached to a servo. The gate can be configured to fall open naturally. The gate is optionally locked in place so that the servo can be turned off with the gate opened or closed, as desired.

The hopper is optionally fitted with various meshes. For example, wire-based parts can be fabricated to increase or decrease the ‘ease’ of feeding. The ease of feeding can therefore be adjusted to correspond with an animal's inclination to eat and the ease or difficulty of the feed offered. The ease or difficulty of the feed offered is dependent upon the size of the food relative to the size of the openings in the mesh and the orientation of the mesh. The same hopper can be fitted with an inter-changeable mesh. A wire format is optionally used to be ‘gentler’ on the animal.

Accordingly, the adapter assembly optionally has one or more of the following features: a) the gate is opened by gravity; b) the gate can be locked closed independent of the actuator mechanism (e.g., manual override); c) an animal's weight will act to open the gate, not close it; d) the gate's closing action pushes an animal away safely, reducing any possibility of injury (e.g., not a guillotine); e) passive locking (e.g., lowering the gate keeps the hopper from being removed); f) the gate's axle provides a hand-hold for the animal; g) the gate/vestibule is too small for the animal to sleep or nest on; h) an adapter component can be formed from translucent material, thereby minimizing environmental impact and allowing observation; i) the coupling prevents the hopper from turning or limits such turning; j) the mounting mechanism is universal for mice and rats (and other laboratory animals); k) a dummy mechanism (e.g., a mechanism without a strain gauge) can be used for manual studies or acclimation; l) the assembly optionally has inter-changeable hopper faces; m) the gate position is optionally locked when closed, allowing the servo motor to be turned off while the gate remains in either position; n) a switch can be used to provide an assessment of the animals motivation for food; o) signaling means, such as visible or audible stimuli, to facilitate training the animals; p) signaling means, such as visible or audible stimuli, to indicate to humans; r) a switch mechanism that a human may use to send a signal to the system; and s) a mechanism to uniquely identify a specific animal or hopper, such as an implanted RFID tag.

Referring specifically to the embodiment illustrated in FIGS. 3A through 3K, an adapter assembly according to one aspect of this invention and according to one embodiment of this invention is generally designated by the numeral 30. Generally, the adapter assembly 30 includes a mounting assembly 32 configured for mounting the adapter assembly 30 to an animal cage assembly such as animal cage assembly 10 shown in FIGS. 1A and 1B, a base assembly 34 configured to house a strain gage (as will be described later), and a hopper assembly 36 configured to contain food (not shown) for feeding an animal contained within an animal cage assembly 10. Though adapter assembly 30 is specifically configured to contain food and facilitate and control the feeding of laboratory animals, a wide variety of alternative assemblies can be mounted to the animal cage assembly 10.

Adapter assembly 30 includes, among other components, an arm 38 connected to a servo (not shown in FIG. 3A), which arm 38 is positioned for moveable contact with a cam 40 that is coupled for rotation of a shaft 42, as will be described later in greater detail. The rotation of the shaft 42 causes pivotal movement of a gate (not shown in FIG. 3A) between an opened position for allowing an animal within the animal cage assembly 10 to have access to food within the hopper assembly 36 and a closed position preventing such access.

The animal is prohibited from opening the gate when the gate is in the closed position. In the closed position, the cam 40 is mechanically grounded against the arm 38, thereby preventing the animal from rotating the gate to an opened position. In this configuration, the servo motor may be turned off, as the relative positions of the arm 38 and cam 40 prevent the gate from moving, irrespective of the servo-motor status.

Referring to FIG. 3B, the mounting assembly 32 of the adapter assembly 30 includes structures by which the adapter assembly 30 can be releasably connected to the animal cage assembly 10. More specifically, the mounting assembly 32 of the adapter assembly 30 is releaseably engageable to the molding 14 of the animal cage assembly 10, thereby releaseably mounting the adapter assembly 30 at a position corresponding to the aperture 22 formed in the side wall 16 of the animal cage 12 of the animal cage assembly 10.

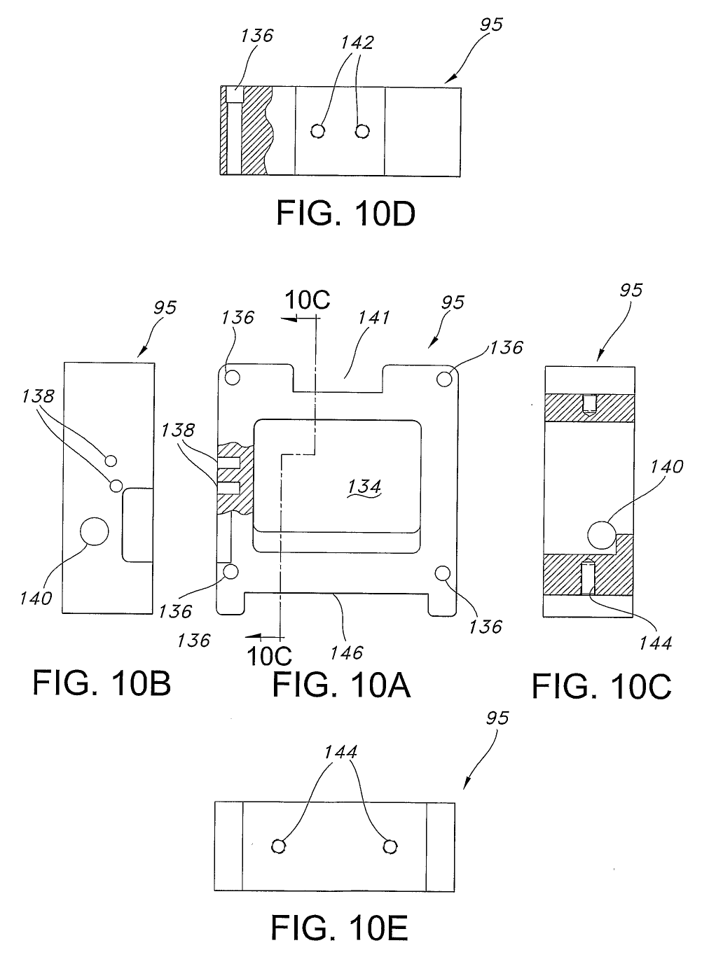

In the embodiment illustrated in FIG. 3B, the mounting components include a clip 44 and a hook 46. The clip 44 is mounted to an adapter component (to be described later in connection with FIGS. 10A through 10E) by means of a plate 48 and fasteners 50 (one shown). The upper portion of the clip 44 is therefore moveable with respect to the adapter component of the adapter assembly 30.

The hook 46 of the mounting assembly 42 is mounted to the adapter component by means of fasteners 52 (one shown). As is indicated by the slots formed in the hook 46 and positioned just to the right of the fasteners 52, the position of the hook 46 with respect to the adapter component is adjustable. Such adjustability of the position of the hook 46, which changes the lateral positioning of the hook 46 with respect to the stationary clip 44, facilitates adjustment of the adapter assembly 30 for mounting to a variety of animal cage assemblies. More specifically, and as is illustrated in FIG. 1B, the side wall 16 of the animal cage 12 is provided with a draft and is therefore positioned in a plane that is not perpendicular to the base 18 of the animal cage 12. In view of the different draft angles that may be provided on the side wall 16 of the animal cage 12, the adjustability of the hook 46 with respect to the clip 44 facilitates the attachment of the adapter assembly 30 to an animal cage assembly 10 independent of the specific draft of the sidewall 16 of the animal cage 12. In other words, whether the sidewall 16 of the animal cage 12 is perpendicular to the base 18 or at some angle with respect to a plane perpendicular to the base 18, the adapter assembly 30 can be adjusted for suitable attachment to that animal cage 12.

The mounting assembly 32 of the adapter assembly also includes a gate 54 coupled to the shaft 42 by means of fasteners 56 (one shown). Though the operation of the gate 54 will be described later in greater detail, FIG. 3B illustrates that the gate 54 will pivot with respect to the remainder of the mounting assembly 32 upon rotation of the shaft 42 about its axis. Accordingly, the gate 54 can be moved from the open position (shown in FIG. 3B, providing a laboratory animal with access to food within a hopper) and a closed position (not shown) in which such access is denied. Mounting assembly 32 of adapter assembly 30 is also provided with a front plate 58 with an aperture corresponding to the aperture formed in the adapter component.

The base assembly 34 of the adapter assembly 30 includes a housing for a strain gage that is used to measure the weight of food contained within the hopper assembly 36. More specifically, the housing of the base assembly 34 includes an enclosure 60 and a cover 62 defining an interior. The enclosure 60 is mounted to an L-bracket 64, which provides interconnection between the base assembly 34 of the adapter assembly 30 and the mounting assembly 32 of the adapter assembly 30. Mounted within the enclosure 60 is a load cell 66 and a bracket 68 (details of which will be described in connection with FIGS. 14A through 14C). A ball nose spring plunger 70 extends within the bracket 68 in order to provide a frictional and releasable engagement of a coupling to be described later. Also, a series of fasteners, including set screws 72, fasteners 74 and spring washers 76, are engaged within or to the bracket 68.

Providing a releasable connection between the hopper assembly 36 and the base assembly 34 of the adapter assembly 30 is a coupling 78 having two (2) dowel pins 80 to prevent rotation of the coupling 78 with respect to the housing assembly 36 and with respect to the base assembly 34. The coupling 78 releasably mounts the hopper assembly 36 over the base assembly 34 in such a way as to transmit the weight of food contained within the hopper assembly 36 to the strain gauge or load cell 66 mounted within the enclosure 60 of the base assembly 34. It is in this manner that the weight of the food within the hopper assembly 36 can be monitored.

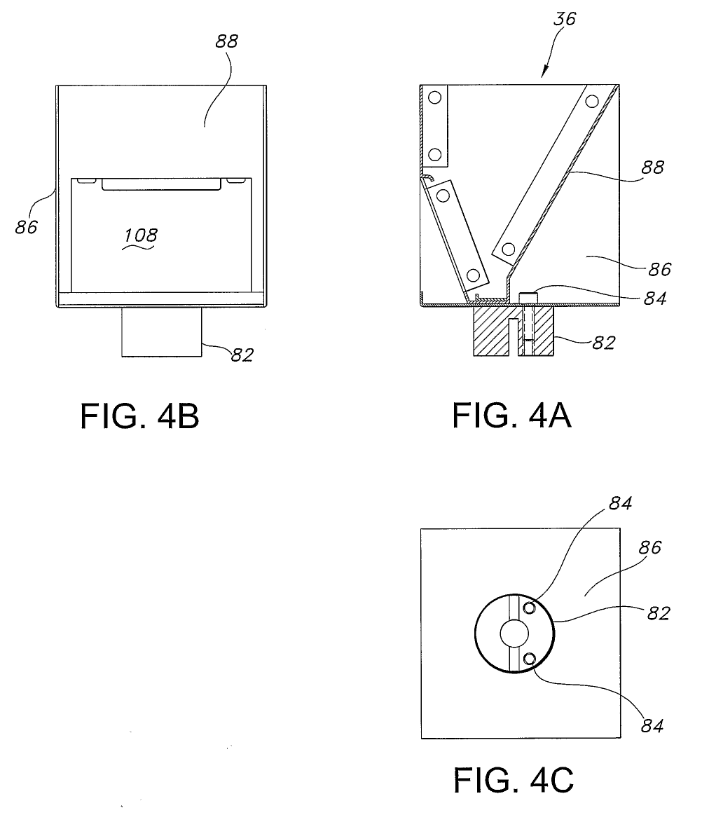

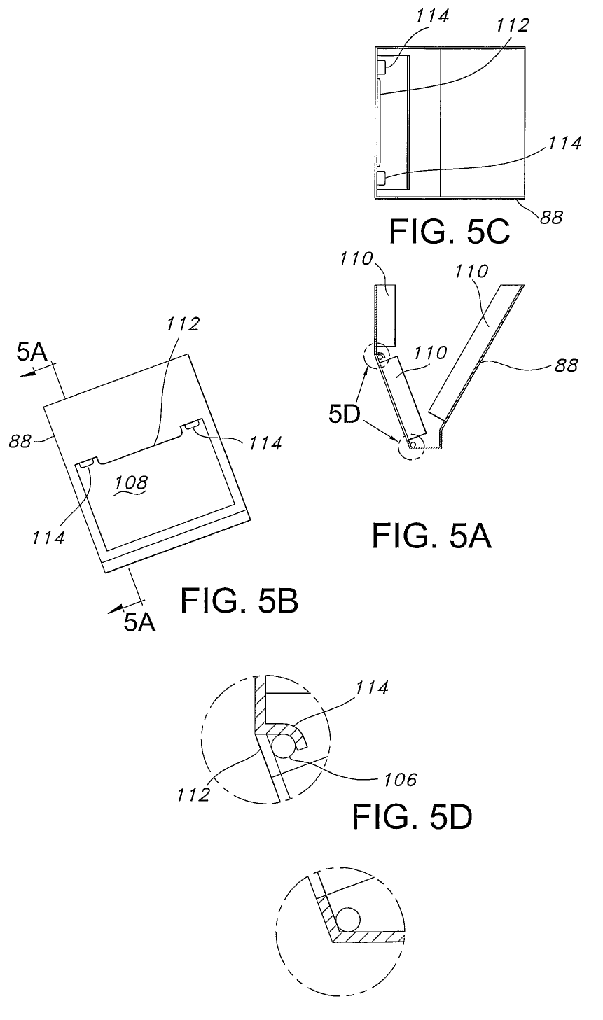

Referring specifically to the hopper assembly 36 of the adapter assembly 30, the hopper assembly 36 includes a puck or support 82 mounted by means of fasteners 84 to a bottom surface of a hopper 86. A screen (details of which will be described in connection with FIGS. 5A to 5D) is mounted within the hopper 86. A stop 90 is provided within the base of the screen 88 in order to capture a mesh (to be described later) within the screen 88, which mesh holds food within the hopper assembly 36 yet provides a laboratory animal with access to the food when the gate is open. Further details of the hopper assembly 36 are described later in connection with FIGS. 4A through 4C.

Referring now to FIG. 3C, the base assembly 34 of the adapter assembly 30 is connected to the L-bracket 64 by means of fasteners 92, and fasteners 94 connect the cover 62 to the enclosure 60. Also, the enclosure 60 includes a connector or receptacle 96 to which a cable can be connected to transmit signals from the load cell 66 within the enclosure 60 to a receiver.

A spring plunger 91 is coupled to the cam 40 of the mounting assembly 32 in order to capture the cam in a selected position to hold the gate 54 of the mounting assembly 32 in a pre-selected position. More specifically, the spring plunger 91 permits retention of the cam 40 in a position selected to hold the gate 54 in the closed position so that the animal is prevented from escaping when the hopper is removed for replacement or cleaning. In addition to the spring plunger 91, the cam may be captured in a selected position using a screw, pin, magnet or any other article or surface capable of capturing the cam. Additionally, with the gate 54 held in the closed position, the servo motor can be turned off. Also, the mounting assembly 32 includes a dowel pin 93 positioned to limit the rotational movement of the cam 40 with respect to the adapter of the mounting assembly 32.

Referring to FIG. 3D, the adapter (designated by the numeral 95) is retained between the L-bracket 64 and the front plate 58 by means of fasteners 97. Also illustrated in FIG. 3D is a central aperture 99 through which the coupling 78 (not shown) is configured to extend. The apertures formed in the L-bracket 64 adjacent the fasteners 92 are provided to facilitate the rapid assembly and disassembly of the L-bracket 64 with the enclosure 60. In particular, the slotted apertures adjacent the fasteners 92 permit the rapid removal of the enclosure 60 from the L-bracket 64 to facilitate the cleaning of the enclosure 60, as the user may clean the sensitive enclosure 60 separate from the other components of the system.

Referring now to FIG. 3E, a servo 100 extends from within the enclosure 60 to transmit movement to the arm 38, which in turn transmits movement to the cam 40 for rotation of the shaft 42 and ultimate pivotal motion of the gate 54. Also illustrated in FIG. 3E is the orientation of the hook 46 with respect to the clip 44. More specifically, the clip 44 extends outwardly from the mounting assembly 32 of the adapter assembly 30 farther as compared to the hook 46. The slots formed in the hook 46 permit linear adjustment of the hook 46 with respect to the adapter 95 by loosening and then re-tightening the fasteners 52.

The enlarged view into the enclosure 60 shown in FIG. 3F reveals additional details of the structure and orientation of the bracket 68, connector 96, and other components housed within the enclosure 60.

To assemble the base assembly 34 to the remainder of the adapter assembly 30, the fasteners 92 coupled to the enclosure 60 are loosened and the enclosure is positioned with the sensor cable receptacle 96 facing the user. The base of the L-bracket 64 is held closest to the user. The base is then lowered so the fasteners 92 pass through the circular portion of the keyholes on the L-bracket 64. The L-bracket 64 is then slid forward so that the aperture 99 is centered on the opening in the enclosure 60 and the fasteners 92 are in the slots of the keyholes. The fasteners 92 are tightened to secure the L-bracket 64 to the enclosure 60. To remove the enclosure 60 for maintenance or cage washing, the foregoing steps are reversed. The coupling 78 is first removed prior to removal of the enclosure 60.

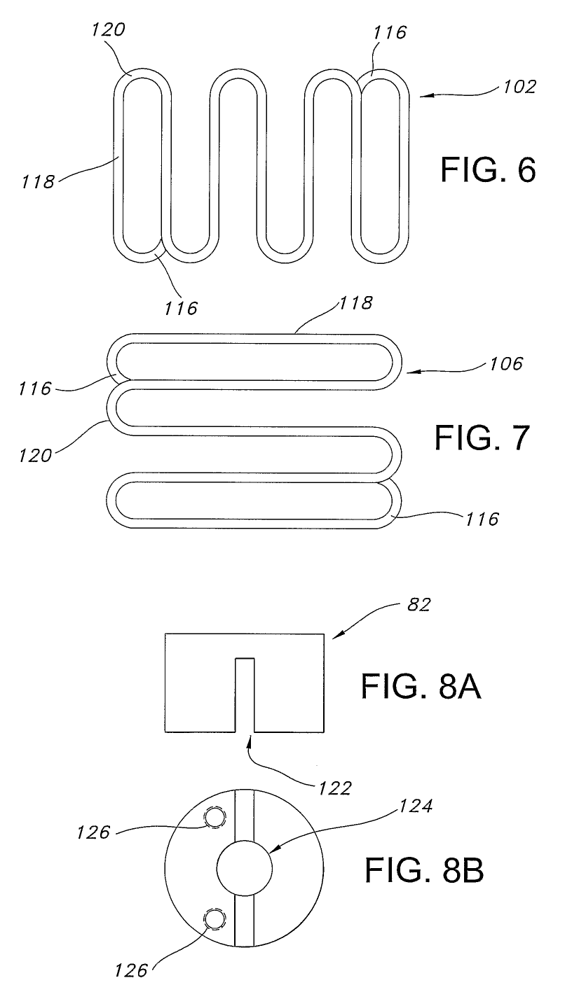

Referring now to FIGS. 3G and 3H, the relationship between the screen component of the hopper assembly 36 and the hopper component of the hopper assembly 36 is illustrated. Specifically, the screen 88 is positioned within the hopper 86 in such a way as to contain food within the hopper assembly 36 while permitting access to that food by an animal within an animal cage such as animal cage assembly 10. Also, a mesh component 102 is captured by surfaces of the screen 88 and a stop component 104. The mesh 102 is therefore releasably engaged with respect to the screen 88 so that it can be removed and replaced, as needed. Also, the releasable engagement between the mesh 102 and the screen 88 facilitates the use of various mesh configurations that can be selected based on the animals being fed, the nature of the food being provided to the animals, and other considerations. Further details of the mesh 102 will be provided with reference to FIG. 6, and further details of the screen 88 will be described with reference to FIGS. 5A through 5D. The manner in which the mesh 102 is captured with respect to the screen 88 will be described with specific reference to FIG. 5D.

Referring to FIG. 3H, a different embodiment of a mesh component, designated as mesh 106, is utilized. Though mesh 106 is similar to mesh 102 in that it is optionally formed from a bent wire material, mesh 106 differs from mesh 102 in that the elongated runs of the wire run in a substantially horizontal direction as opposed to the vertical direction of the runs of the mesh 102. In either embodiment, meshes 102 and 106 are captured by surfaces of the screen 88 for releasable engagement.

As is illustrated in FIGS. 3G and 3H, the screen 88 is optionally spot welded to the hopper 86. This attachment forms a substantially permanent or long-lasting connection between the screen 88 and the hopper 86. Other means of connection between the screen 88 and the hopper 86 are contemplated as well, whether they are substantially permanent or temporary for interchangeability.

FIGS. 3I and 3J are end and side views, respectively, of an embodiment of the adapter assembly coupled to an animal cage assembly. The relationship between the adapter assembly 30 and the animal cage assembly 10 is illustrated in FIGS. 3I and 3J. As shown in FIG. 3I, the boundaries of the adapter assembly 30 do not extend past the height and the width of the animal cage 12. Accordingly, the animal cage assemblies may be stacked side by side, stacked on top of each other, or placed on a level table. For example, if the base of the adapter assembly 30 extended past the base of the animal cage 12, and both were placed on a level table, the adapter assembly would prop up a single side of the animal cage 12, perhaps disturbing the animal.

As illustrated in FIG. 3J, the clip 44 is configured to engage against the flange 24A and perimeter 26 of the molding 14 of the animal cage assembly 10. In such an arrangement, the hook portion of the hook 46 engages the flange 24C and perimeter 26 of the molding 14. Such engagement by the clip 44 and hook 46 releasably engages the adapter assembly 30 to the animal cage assembly 10. The adjustability of the hook 46 with respect to the clip 44 facilitates the attachment of the adapter assembly 30 to an animal cage assembly 10 independent of the draft of the sidewall 16 of the animal cage 12. Accordingly, despite the fact that the side wall of the animal cage 12 shown in FIG. 3J maintains a draft angle, the adapter assembly 30 is positioned substantially parallel to the base of the animal cage. The hook portion 46 also substantially prevents the adapter assembly 30 from shifting.

As illustrated in FIG. 3K, a switch mechanism 193 is attached to the arm 38 of the adapter assembly 30. The switch mechanism 193 is activated by any slight movement of the gate 54. The switch 193 is in mechanical contact with a dowel 191 on the cam 40, via hook portion 192, and in electrical connection with the computer module which monitors the activity of the switch. The switch provides an evaluation of the animal's motivation to eat the food contained in the hopper. In use, the animal pushes or pulls the gate thereby activating the switch. The user may configure the system to open the gate 54 after the animal activates the switch mechanism 193 by contacting the gate a pre-determined number of times.

Furthermore, the switch enables the user to create a hurdle for the animal to obtain the food by requiring that the switch be activated a pre-determined number of times before the gate will open. For example, the user may require that the switch be activated five times for the gate to open to allow the animal to eat a first time. Moreover, if the animal wants to eat a second time in a single day the user may require that the switch be activated ten times for the gate to open to allow the animal to eat.

In use, when the animal contacts the gate 54, the cam 40 slightly rotates towards the arm 38. By virtue of the frictional contact between the dowel 191 of the cam 40 and the hook 192 of the switch mechanism 193, the arm 194 depresses the switch mechanism 193, thereby activating it. The switch mechanism 193 relays an electrical pulse to the computer which monitors the status of the switch mechanism 193. The switch mechanism 193 may be any type of detection mechanism, e.g. a vibration sensor, accelerometer, switch, etc.

FIGS. 4A, 4B, and 4C are side, front, and bottom views, respectively, of an embodiment of a hopper assembly configured for use in the adapter assembly shown in FIG. 3A. According to one exemplary embodiment, a food hopper is a stainless steel cube with a slotted feeding interface and a post coupling. A mouse hopper holds solid food, for example 50 grams of solid food, while a rat hopper holds a larger supply of food (150 grams, for example). The screen configuration is optionally changeable using a clip mechanism to allow for different types of food.

Referring specifically to the embodiment illustrated in FIGS. 4A through 4C, an exemplary hopper assembly 36 is illustrated. Specifically, the puck or support component 82 of the hopper assembly 36 is fastened to a bottom surface of the hopper 86 by means of two (2) fasteners 84. Together, the screen 88 and the hopper 86 of the hopper assembly 36 define an access opening 108, which allows selective access to food within the hopper assembly 36 for a laboratory animal. Further details of the screen 88 are shown in FIGS. 5A through 5D, and further details of the puck component 82 are shown in FIGS. 8A and 8B.

FIGS. 5A, 5B, 5C, and 5D are side, front, top, and enlarged views, respectively, of an embodiment of a screen component configured for use in the hopper assembly shown in FIG. 4A. Referring specifically to the embodiment illustrated in FIGS. 5A through 5D, screen 88 of the hopper assembly 36 is optionally formed from sheet metal bent into a selected configuration. As is best illustrated in FIG. 5A, screen 88 includes plural flanges 110 along its edges to facilitate connection (e.g., by spot welding) to the interior surface of the hopper 86 (not shown in FIG. 5A). Also, screen 88 has a lip portion 112 and brackets 114 positioned and shaped to releasably engage a mesh such as mesh 106 in juxtaposition with the aperture 108. Accordingly, and as is illustrated in FIG. 5D, portions of a wire-formed mesh 106 are captured between the lip portion 112 and the brackets 114 at an upper edge of the aperture 108. The stop component (shown in FIGS. 3G and 3H) and designated by the numeral 104 supports a lower portion of the mesh 106 to maintain the mesh 106 in the space between the lip portion 112 and brackets 114. Though not shown in FIG. 5D, the stop 104 would be positioned to the right of the bottom portion of the mesh 106 in the base of the screen 88. Removal of the stop 104 would permit removal of the mesh 106 for cleaning, replacement, or other purposes.

Referring to FIG. 6, which provides a front view of an embodiment of a mesh component configured for use with the screen component shown in FIG. 5A, mesh 102 is optionally formed from an elongated segment having end portions 116, elongated runs 118, and bends 120. While a metallic wire is optionally selected as a material for the mesh 102, other metallic or non-metallic materials are contemplated as well. It has been discovered, however, that a rounded or circular cross-sectional shape of the elongated runs 118 of the mesh 102 provides a surface well adapted for contact by laboratory animals while feeding. In other words, the elimination of sharp edges from the mesh 102 is better suited for this purpose. It should be understood by one skilled in the art that the mesh component may be formed by a die-casting or injection molding process.

FIG. 7 is a front view of another embodiment of a mesh component configured for use with the screen component shown in FIG. 5A. Like mesh 102, the mesh 106 illustrated in FIG. 7 also has end portions 116, elongated runs 118, and bends 120. The primary difference between the mesh 102 shown in FIG. 6 and the mesh 106 shown in FIG. 7 is that the elongated runs 118 of the mesh 102 run substantially vertically while the elongated runs 118 of the mesh 106 run substantially horizontally.

FIGS. 8A and 8B are side and bottom views, respectively, of a support component configured for use in the hopper assembly shown in FIG. 4A. Referring specifically to the embodiment illustrated in FIGS. 8A and 8B, the puck component 82 of the hopper assembly is provided with a slot 122 to accommodate the dowel pins 80 of the coupling 78 (FIG. 3B), thereby preventing rotational movement of the puck 82 with respect to the coupling 78. Puck 82 also includes an aperture 124 extending through it to receive the coupling 78. Mounting holes 126 are provided for engagement of fasteners 84, which interconnect the puck 82 to the hopper 86.

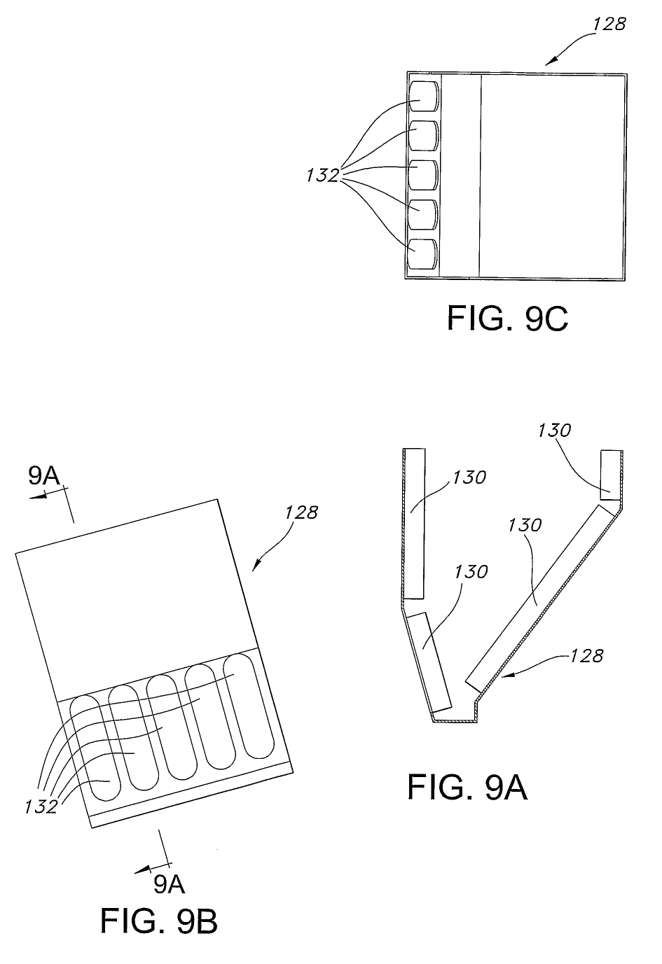

FIGS. 9A, 9B, and 9C are side, front, and top views, respectively, of another embodiment of a screen component, generally designated by the numeral 128, that can be used in a hopper 86 of the hopper assembly 36. Screen 128 differs from screen 88 in that it is a one-piece component as opposed to the assembly of the screen 88 and the mesh 102 or 106. Like screen 88, screen 128 is optionally formed from sheet metal that is cut or otherwise formed to a desired shape and bent into a desired configuration. Screen 128 includes a series of flanges 130 to facilitate interconnection of the screen 128 and interior surfaces of the hopper 86. In order to provide a laboratory animal with access to food within the screen 128 of the hopper assembly 36, the body of screen 128 defines a plurality of apertures 132 (five (5) such apertures 132 being illustrated in FIGS. 9B and 9C). As illustrated by FIGS. 9A-9C, for example, a screen for use in a hopper can take a wide of variety forms and configurations. Such a screen can also be formed form a wide variety of metallic and non-metallic materials.

FIGS. 10A through 10E illustrate an adapter component configured for use in the adapter assembly shown in FIG. 3A. The adapter optionally takes the form of a translucent, polycarbonate block sandwiched between a stainless steel front plate and the L-bracket, thereby providing isolation for the hopper.

Referring specifically to the embodiment illustrated in FIGS. 10A-10D, adapter 95 defines a central aperture 134 through which an animal can have access to food within the hopper assembly 36. Adapter 95 includes four (4) mounting holes 136 to accommodate fasteners such as fasteners 97 shown in FIG. 3D. Adapter 95 also includes mounting holes 138 provided in a side surface to receive dowel pins such as the dowel pin 93 shown in FIG. 3C. An aperture 140 is also provided in the adapter 95 to accommodate the shaft 42 shown in FIG. 3B.

A recess 141 is provided in a top surface of the adapter 95 in order to receive the clip 44 as illustrated in FIG. 3B, and mounting holes 142 are provided in the area of recess 141 so that fasteners 50 can be used to engage the plate 48 and clip 44 of the mounting assembly 32 to the adapter component 95. Mounting holes 144 are provided in the bottom surface of the adapter 95 in the vicinity of a recess 146. The recess 146 accommodates the adjustable hook 46 as shown in FIG. 3B, and the mounting holes 144 accommodate fasteners 52 (also shown in FIG. 3B).

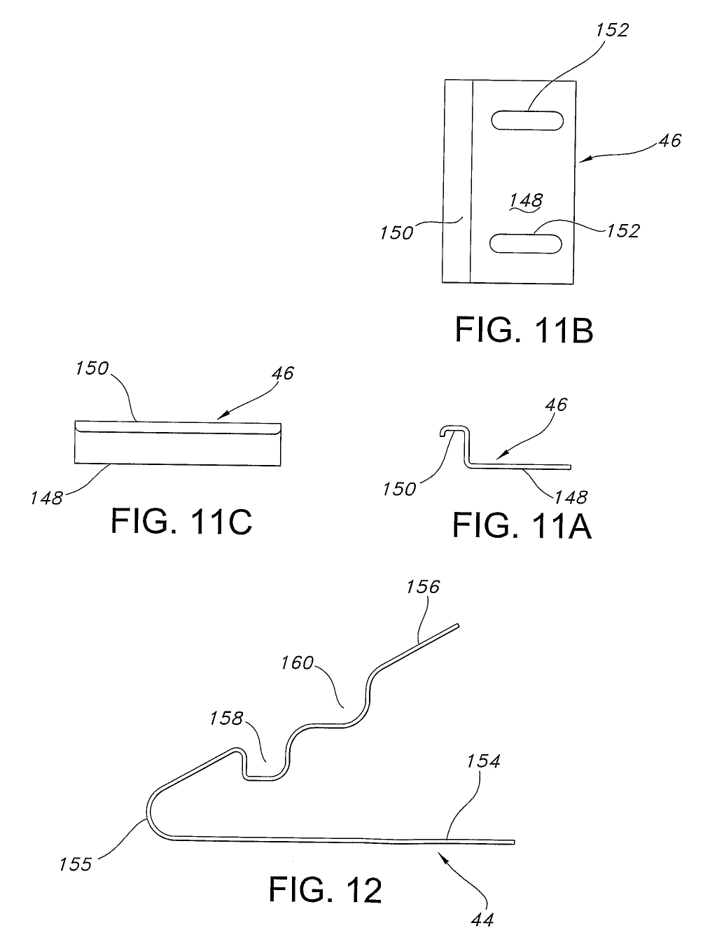

FIG. 11A is a side view of an embodiment of a hook component configured for use in the adapter assembly shown in FIG. 3A. The hook attaches to the bottom of the opening 146 of adapter 95 and is slotted to allow for adjustment to the angle of the mounting surface of cage. Referring to FIGS. 11A through 11C, an embodiment of a hook component 46 is illustrated. Hook 46 includes a mounting portion 148 and a hook portion 150. The mounting portion 148 facilitates adjustable mounting of the hook 46 to the adapter 95, and hook portion 150 of hook 46 provides releasable engagement between the mounting assembly 32 of adapter assembly 30 and an animal cage assembly 10. The mounting portion 148 of the hook 46 includes elongated apertures or slots 152 (two (2) shown in FIG. 11B) to accommodate fasteners 52. The slots 152 are elongated in order to provide advantageous adjustment of the position of the hook 46 with respect to the adapter 95. As described previously, such adjustments of the hook 46 makes it possible to adjust the adapter assembly 30 for attachment to a variety of animal cages that may have different drafts or wall configurations.

FIG. 12 is a side view of an embodiment of a clip component configured for use in the adapter assembly shown in FIG. 3A. The clip attaches to the top of a cage opening and allows for rapid mounting and dismounting to the cage opening. According to one embodiment, the clip is made from SS spring steel.

Referring to FIG. 12, the clip 44 has a mounting portion 154 separated by a bend 155 from an engagement portion 156. The mounting portion includes at least one aperture (not shown) to accommodate a fastener 50 for coupling clip 44 to adapter 95 of mounting assembly 32. The engagement portion 156 can be pivoted or flexed with respect to the mounting portion 154 to facilitate engagement of the clip 44 to a surface of an animal cage. In order to allow such flexure of clip 44, the clip is optionally formed from stainless steel spring steel or another suitable or equivalent material.

A recess 158 formed in the engagement portion 156 accommodates an edge of an aperture formed in an animal cage. More specifically, referring to FIGS. 1A and 1B, the recess 158 is configured to engage against the flange 24A and perimeter 26 of the molding 14 of the animal cage assembly 10. In such an arrangement, the hook portion 150 of the hook 46 shown in FIGS. 11A through 11C would engage the flange 24C and perimeter 26 of the molding 14. Such engagement by the clip 44 and hook 46 releasably engages the adapter assembly 30 to the animal cage assembly 10.

A second recess 160 is optionally formed in the engagement portion 156 of the clip 44 in order to provide clearance for a structure of the animal cage such as a lid portion of the animal cage. The clip 44 is optionally formed by compressing stainless steel spring steel between a punch component and a die component that is contoured to form the desired shape of the clip. Other forming methods, including molding, bending, and cutting for example, can be utilized.

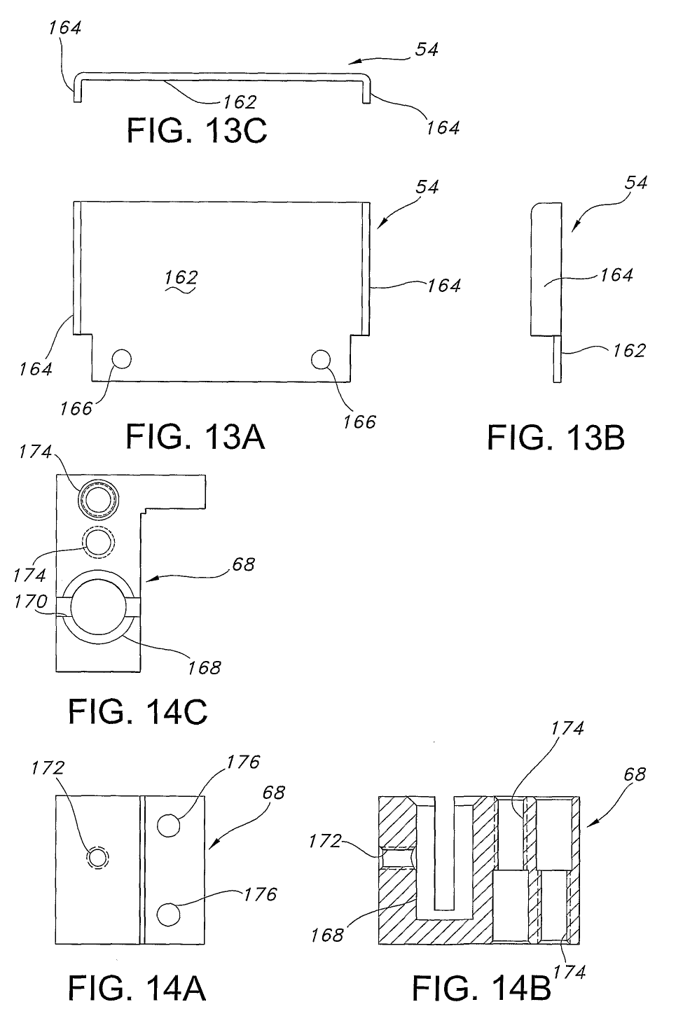

FIGS. 13A, 13B, and 13C are front, side and end views of an embodiment of a gate component configured for use in the adapter assembly shown in FIG. 3A. The gate pivots on a shaft (swinging upward), thereby gently pushing an animal away from the hopper. A cam is attached to the end of the shaft on the outside of the adapter which allows for manual movement. A spring plunger is attached to the cam which locates in a hole in the adapter's side for locking the gate in the closed position. A dowel pin is located in the adapter's side to limit the travel of the cam and to position the gate in the closed position. In the closed position, the animal has no access to the food in the hopper and is prevented from escaping through the opening. In the open position, the gate lays flat on the base of an interior channel of the adapter and overlaps on top of the hopper's tray to prevent an animal from pulling the coupling out of the load cell, to prevent escape, and to keep spillage of food contained.

The gate can be operated manually by moving the cam up and down or automatically with a servo mounted on the side of the enclosure. The servo arm is activated via computer software to operate at timed intervals, thereby allowing or disallowing access to the food hopper. In an exemplary embodiment, for example, the servo arm receives a signal from the computer software to close the gate after a predetermined amount of food has been consumed thus restricting the total amount the animal is permitted to consume. The food restriction function of the adapter assembly is a beneficial tool in biology wherein food restriction can increase the longevity of the animal. The adapter assembly is not limited to feeding the animal once per day. The food may be offered to the animal in intervals throughout the day or the food may be offered the entire day. The user determines the appropriate feeding time(s) and feeding time duration.

On a mouse assembly, for example, the shaft acts as a launching pad for the animal providing leverage for entering and eating once inside the adapter tunnel. The gate moves slowly when closing with no pinch points to safely push the animal out of the adapter tunnel. On a rat assembly, for example, the opening in the adapter is larger. A locking pin which is slid through two holes in the adapter is installed for small animals to prevent escape and can be removed to provide maximum access to the food hopper when the animal has grown.

Referring specifically to the embodiment illustrated in FIGS. 13A through 13C, the gate 54 of the mounting assembly 32 provides a substantially flat surface 162 flanked by flanges 164. The surface 162 of gate 54 provides a platform when in the open position on which an animal can step and which can receive food that falls from the hopper as an animal feeds. When in a closed position, however, the surface 162 of the gate 54 provides a blocking function that prevents the animal from accessing the food in the hopper, thereby preventing or ending a feeding event or feeding bout.

The shape of the gate 54 is advantageously selected in order to be animal-friendly. Specifically, the edges of the gate 54 are rounded and provided with flanges 164 so as to prevent entrapment of an animal as the gate 54 moves from the closed to opened positions or from the opened to closed positions. Also, the shape and operation of the gate 54 serves to push an animal safely away from the feed hopper to end a feeding cycle. Such pivotal action of the gate 54, coupled with the shape of the gate 54, minimizes the risk of harming the animal.

Gate 54 also includes apertures 166 to accommodate fasteners, such as fasteners 56 shown in FIG. 3B, which connect the gate 54 to the shaft 42 of the mounting assembly 32. More specifically, the apertures 166 in the surface 162 of the gate 54 permit coupling of the gate 54 to the shaft 42 so that rotation of the shaft 42 causes pivotal rotation of the gate 54 about an axis of the shaft 42.

FIGS. 14A, 14B, and 14C are front, side and top views, respectively, of an embodiment of a bracket component configured for use in the adapter assembly shown in FIG. 3A. Referring specifically to the embodiment illustrated in FIGS. 14A through 14C, bracket 68 defines a blind hole 168 that releasably receives the coupling 78 that extends from the base assembly 34 of the adapter assembly 30 up to the hopper assembly 36 of the adapter assembly 30. The blind hole 168 is flanked by slots 170 that receive dowel pins 80 of the coupling 78, thereby resisting or preventing rotational movement of the coupling 78 with respect to the bracket 68. Such resistance to rotation of coupling 78 (both by virtue of the slots 170 in the bracket 68 and the slot 122 of the puck 82) prevents or limits the rotational movement of the hopper 86 with respect to the remainder of the adapter assembly 30. Such limitation of rotational movement reduces the opportunity for the hopper 86 to contact other structures, thereby reducing the possibility of an inaccurate reading of the strain gage.

Bracket 68 also includes a mounting hole 172, which accommodates the ball nose spring plunger 70 shown in FIG. 3B. As described previously, the ball nose spring plunger 70 provides frictional engagement with the coupling 78 to resist the removal of the coupling 78 from the bracket 68. While coupling 78 remains removable from the bracket 68, the ball nose spring plunger 70 helps to retain the coupling 78 in the bracket 68 when the hopper assembly 36 is removed from the top of the coupling 78. In other words, the ball nose spring plunger 70 provides increased friction between the coupling 78 and the bracket 68 as compared to the friction between the coupling 78 and the puck 82 of the hopper assembly 36.

The bracket 68 also includes threaded holes or apertures 174 to receive set screws such as set screws 72 shown in FIG. 3B. The set screws 72 are provided to adjust the position of the bracket 68, or to stabilize the bracket 68, with respect to a surface of the enclosure 60 or the cover 62.

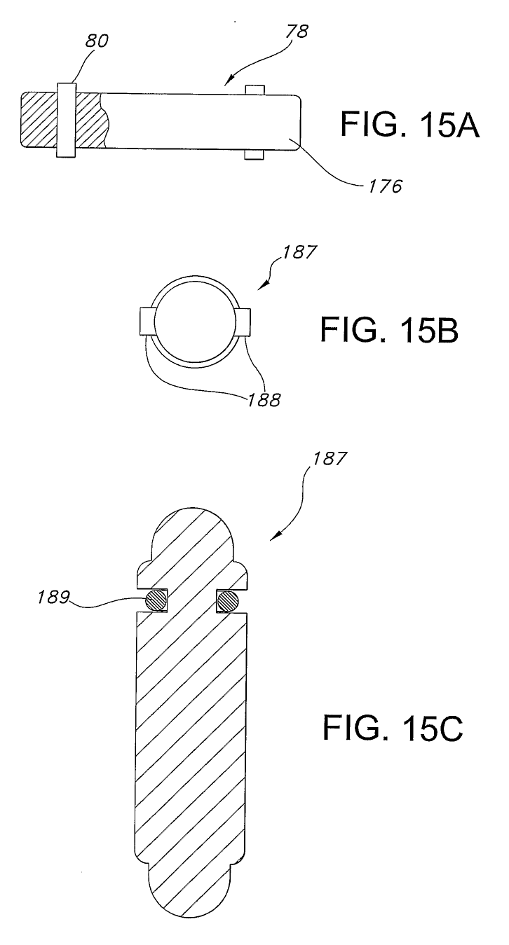

FIG. 15A is a partial cross-sectional side view of an embodiment of a coupling assembly configured for use in the adapter assembly shown in FIG. 3A. The coupling optionally includes a cylindrical rod which connects the strain gauge cell to the hopper or water device. It is optionally symmetrical so that either end of the rod can be inserted into the strain gauge cell and/or food hopper.

Referring to FIG. 15A, which illustrates an exemplary embodiment of the coupling 78, the coupling 78 is optionally formed from a shaft 176 having holes through which dowel pins 80 are pressed. Though shaft 176 of coupling 78 is optionally formed from a rod material to provide a round or rounded cross-sectional shape, the coupling 78 can be formed from a wide variety of materials having a wide variety of shapes. For example, dowel pins 80 are provided through shaft 176 to co-act with slots in the puck 82 and the bracket 68 to prevent rotational movement. Alternatively, the coupling 78 can be provided with a shaft having a non-circular cross-sectional shape to prevent such rotation without the need for dowel pins 80. For example, coupling 78 can be provided with a shaft 176 formed from a square shaft or a shaft having another cross-sectional shape that is non-round.

FIGS. 15B and 15C illustrate another exemplary embodiment of a coupling assembly configured for using in the adapter assembly shown in FIG. 3A. This embodiment of the coupling 187 is optionally formed from a polymeric material to reduce potential damage to the bracket 68. Under an applied torsion load, the polymeric material of the coupling 187 will elastically yield, thereby substantially reducing the stress applied to the bracket 68. The coupling includes flange portions 188 to co-act with slots in the puck 82 and the bracket 68 to prevent rotational movement.

A seal 189 is provided at one end of the coupling 187. Though not shown in FIG. 15C, the outer diameter surface 189 is preferable configured to extend beyond the outer surface of the coupling's body. The frictional contact between the seal 189 and either the bracket 68 or the puck 82 enhances the containment of the coupling 187, depending upon the orientation of the coupling. A seal on both sides of the coupling 187 is also contemplated to further enhance the containment of the coupling. Furthermore, the utilization of the seal 189 eliminates the need for hole 172 and ball nose spring plunger 70, which also provide frictional engagement with the coupling 78 to resist the removal of the coupling 78 from the bracket 68.

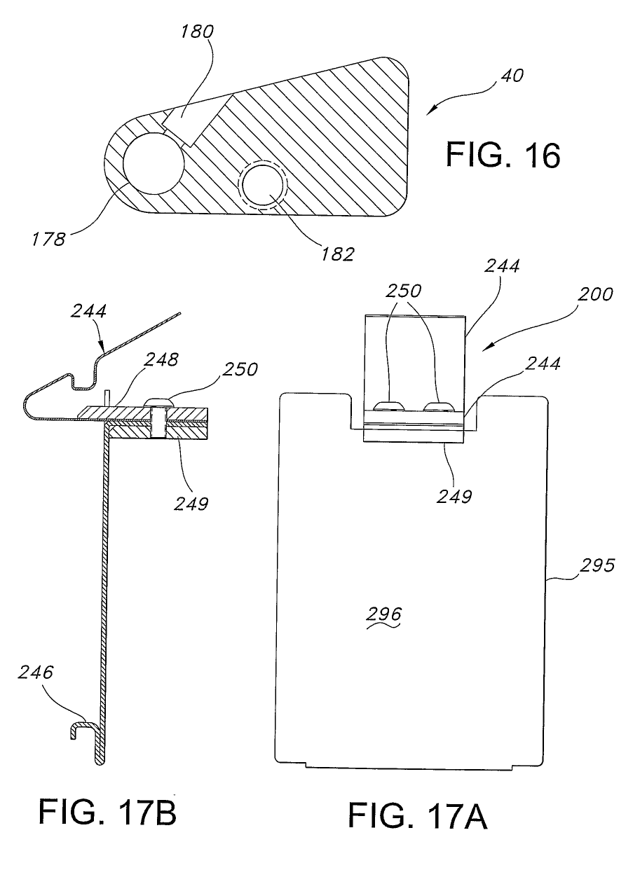

FIG. 16 is a cross-sectional side view of an embodiment of a cam component configured for use in the adapter assembly shown in FIG. 3A. Referring to the embodiment of cam 40 illustrated in FIG. 16, the cam 40 has a shape configured to provide requisite movement with respect to the arm 38 based on contact between the arm 38 and cam 40, as shown in FIG. 3A. The cam 40 is provided with an aperture 178 to accommodate the shaft 142, and a fastener can be inserted by means of an aperture 180 in the cam 40 in order to secure the engagement between the cam 40 and the shaft 42. Also, the use of a fastener through the aperture 180 of the cam 40 prevents rotational slippage of the cam 40 with respect to the shaft 42. The cam 40 is also provided with an aperture 182, preferably threaded, to receive the spring plunger 91 as shown in FIG. 3C.

FIGS. 17A and 17B are front and side views of an embodiment of a blocker assembly configured for use with the animal cage shown in FIG. 1A. Clip and hook components of the blocker assembly attach to the cage opening to block the opening and prevent an animal from escaping when an adapter assembly is removed.

Referring to FIGS. 17A and 17B, a blocker assembly, generally designated by the numeral 200, is illustrated. Blocker assembly 200 is configured for use with a cage assembly such as animal cage assembly 10 in order to block an aperture such as aperture 22. The blocker assembly 200 therefore provides a barrier to prevent the escape of an animal through an aperture in the animal cage when the adapter assembly 30 or other equipment is removed from the cage. The blocker assembly 200 also illustrates that any of a number of assemblies or components can be mounted to a cage assembly such as assembly 10 to provide a wide variety of functions. For example, any of a variety of feeding assemblies can be coupled to the animal cage. Also, a variety of barriers can be provided as can exercise equipment and other equipment useful for laboratory experiments.

The blocker assembly 200 includes a clip 244, like clip 44 of adapter assembly 30, for engagement with a surface of an animal cage. The clip 244 is positioned for cooperation with a hook 246 of a blocker 295. The clip 244 is coupled to the blocker 295 by means of an assembly of a plate 248, a support 249, and a fastener 250 that couples the clip 244, plate 248, and support 249 together. The blocker 295 of the blocker assembly 200 is provided with a contiguous surface 296 that is configured to block an animal. The surface 296 can also comprise a screen, mesh or any other suitable material.

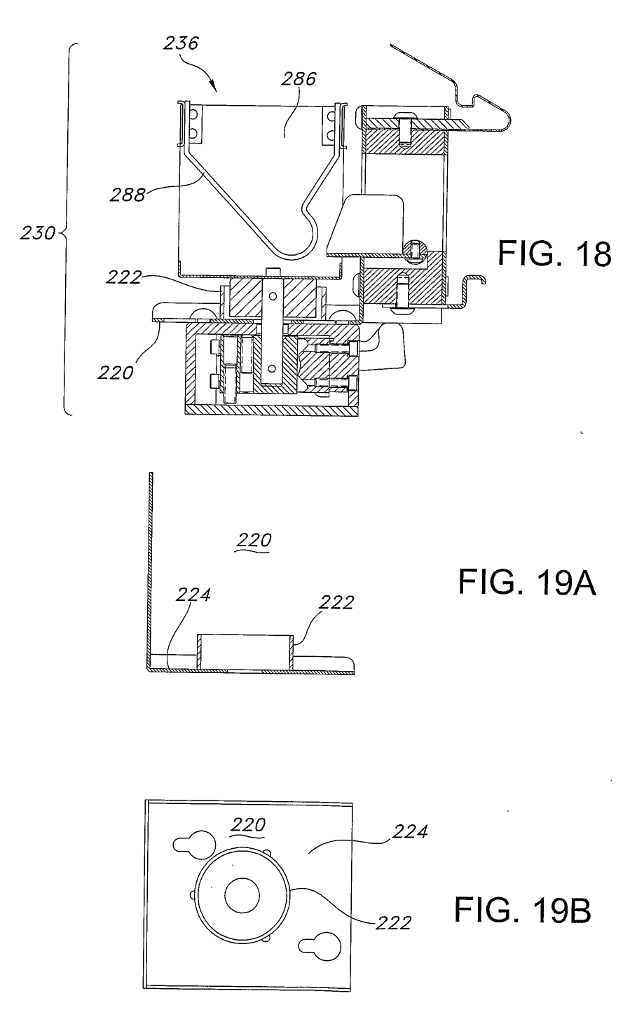

Referring to FIG. 18, another exemplary embodiment of an adapter assembly 230 is illustrated. The adapter assembly 230 is similar to the adapter assembly 30 illustrated in FIG. 3B with the exception of modifications to the L-bracket 220 and the hopper assembly 236.

Referring now to FIGS. 18, 19A and 19B, L-bracket 220 is similar to L-bracket 64 described with reference to FIGS. 3B-3D, however L-Bracket 220 includes a cylindrical wall 222 protruding from the mounting surface 224 of the L-bracket. The cylindrical barrier 222 is positioned to limit food particles and/or liquid leaked from the hopper from entering the blind hole 168 formed in the bracket 68 illustrated FIGS. 14A through 14C. As mentioned above, blind hole 168 receives the coupling 78 that extends from the base assembly 34 up to the hopper assembly 36.

It is envisioned that a significant accumulation of liquid within the blind hole 168 could potentially disturb the electronic components of the base assembly 34. Furthermore, food pellets or particles entrapped within the blind hole 168 could complicate the insertion and/or removal of the coupling 78 from the blind hole 168. It may be difficult for the user to remove food particles from the blind hole 168 or the interior of the base assembly 34. Thus, by virtue of the cylindrical barrier 222, the food particles and water would collect on the mounting surface 224 of the L-bracket without entering the blind hole 168, facilitating easy clean-up of the adapter assembly 230. The barrier 222 should be of sufficient height to limit food particles from entering the blind hole 168, but low enough to allow the hopper 236 to mate with the base assembly 234. The cylindrical barrier 222 may be welded, fastened or formed on mounting surface 224 of the L-bracket.

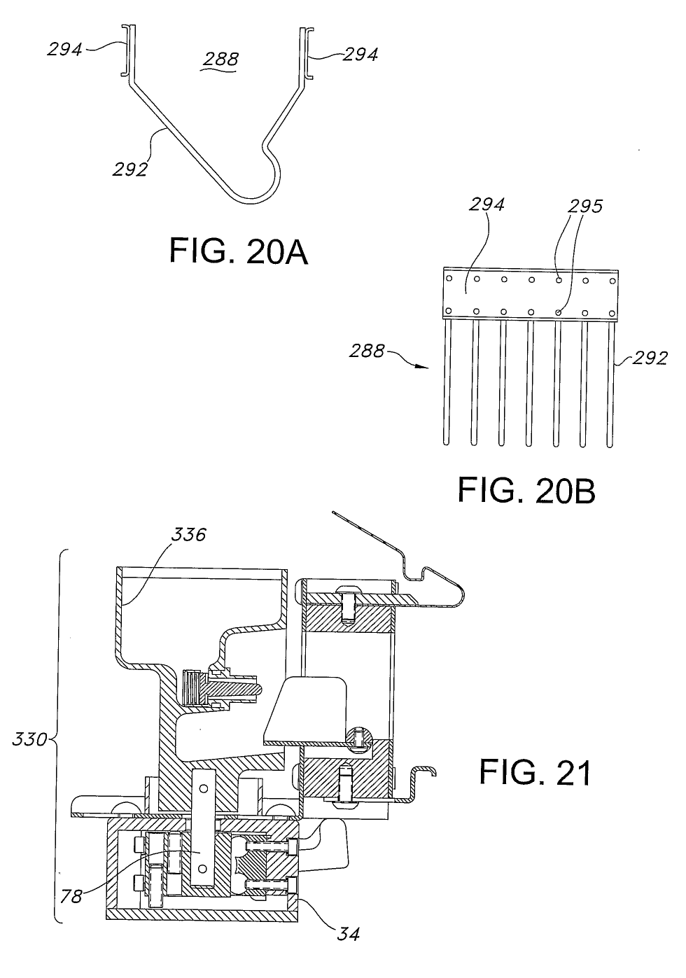

Referring now to FIGS. 18, 20A and 20B, another exemplary embodiment of a screen 288 is illustrated. The screen 288 holds food within the hopper assembly 236 yet provides a laboratory animal with access to the food when the gate is open. The screen 288 generally comprises a plurality of formed wires 292 coupled to opposing headers 294. The opposing headers 294 are designed to snap onto the top end of the hopper 286, as shown in FIG. 18. The screen 288 is specifically shaped to allow the animal access to the contained food from the top, side or bottom of the hopper.

The wire format is optionally used to be ‘gentler’ on the animal. As mentioned above, rounded or circular cross-sectional shape of the wires provides a surface well adapted for contact by laboratory animals while feeding. In other words, the elimination of sharp edges from the wires 292 is better suited for this purpose.

An animal consumes food by gnawing pieces off of the food pellets accessible between the wires 292. The distance between the wires 292 may be designed to be larger than the animal muzzle, but smaller than the food pellet. The diameter of the wires 292 as well as the distance separating the wires may be tailored to the size of the food or to increase or decrease the ‘ease’ of feeding. The ease of feeding can therefore be adjusted to correspond with an animal's inclination to eat and the ease or difficulty of the feed offered. The ease or difficulty of the feed offered is dependent upon the size of the food relative to the distances between adjacent wires 292. A hopper may be fitted with an inter-changeable screen.

In one exemplary embodiment, the wires 292 are formed from Stainless Steel, although it should be understood that the wires may be formed from a variety of metallic or non-metallic materials and may be extruded, molded or die-cast. Each wire 292 may be welded to the headers 294, as shown by the weld spots 295 illustrated in FIG. 20B. The wires may also be fastened to the headers 294 using any fastening means known in the art.

Referring now to FIG. 21, another exemplary embodiment of an adapter assembly 330 is illustrated. The adapter assembly 330 is similar to the adapter assembly 230 illustrated in FIG. 18, however in this embodiment, the food hopper assembly 236 is replaced with a water hopper assembly 336. In practice, the water hopper assembly 336 contains water or any other liquid used to hydrate the laboratory animal. The water hopper assembly 336 is adapted to operate with the base assembly 34 and the gate 54 in the same manner as the food hopper assembly 236.

Similar to the previously described food hoppers, the water hopper assembly 336 is coupled to the base assembly 34 via coupling 78. The coupling 78 releasably mounts the water hopper assembly 336 over the base assembly 34 in such a way as to transmit the weight of liquid contained within the water hopper assembly 336 to the strain gauge or load cell 66 mounted within the enclosure 60 of the base assembly 34. It is in this manner that the weight of the liquid within the water hopper assembly 336 can be monitored.

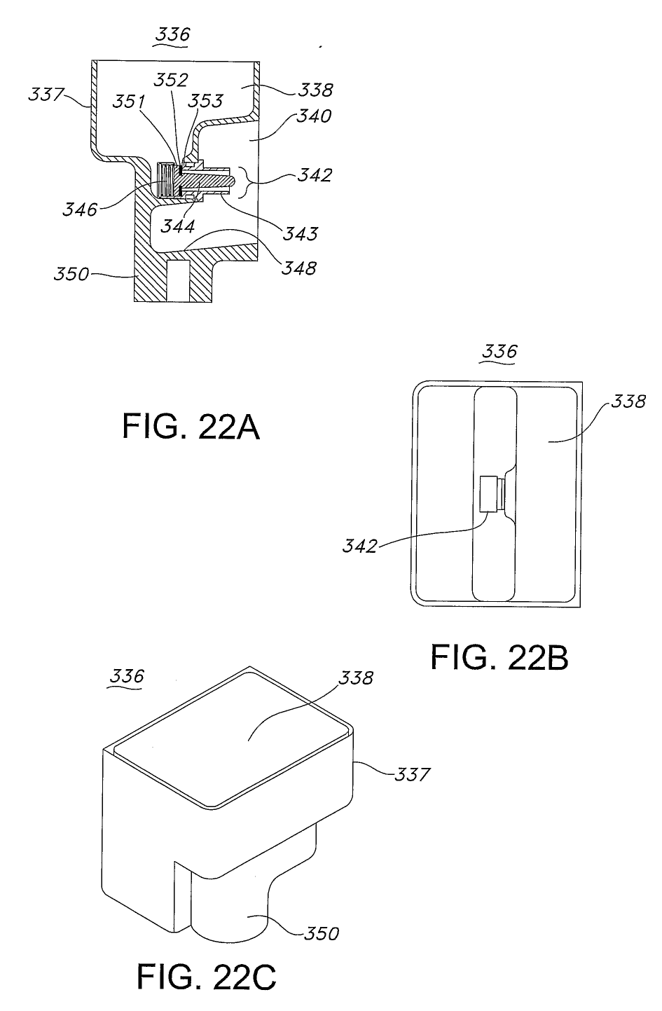

Referring now to the detailed drawings of the water hopper assembly 336 illustrated in FIGS. 22A-22C, the water hopper assembly 336 generally includes a body portion 337, and a spring loaded valve assembly 342 coupled to the body portion 337. The body portion 337 includes a reservoir 338 sized to contain a sufficient volume of water to hydrate an animal. The reservoir 338 may be sized to hold any pre-determined volume of liquid. The top end of the reservoir 338 is optionally open to the atmosphere, as shown, such that laboratory personnel can quickly and easily refill the reservoir or determine if the reservoir needs to be replenished. An integral support 350 is disposed at the bottom surface of the body portion 337. An aperture 352 formed in the integral support 350 is sized to releasably carry the coupling 78, as shown in FIG. 21.

The spring loaded valve assembly 342 is positioned to face the interior of an animal cage for the purpose of feeding and configured to release a controlled supply of liquid to the animal. The valve assembly 342 comprises a valve housing 343 clipped, clamped, snapped, fastened or integral with the body portion 337 of the hopper assembly 336. A compressible spring 336 positioned within the housing 343 bears on an end of a moveable nipple 344 (or valve) to seat the shoulder 351 of the nipple 344 with the valve seat 353 of the body portion 343.

In use, when the gate is in the open position, the laboratory animal depresses the nipple 344 of the valve assembly 342 to obtain water or any other liquid is from the reservoir 338. More specifically, as the animal depresses the nipple 344, the spring 346 held in the valve housing 343 compresses, and a gap develops between the valve seat 353 and the shoulder 351 of the nipple 344. Liquid from the reservoir flows through the gap (not shown) under the force of gravity, and between the nipple 344 and the valve housing 343 towards the mouth of the laboratory animal. The spring constant of the spring is desirably low enough to permit the animal to easily depress the nipple 344.

When the drinking bout is complete, the animal releases the nipple 344, permitting the spring 346 to return to its expanded state and the shoulder 351 of the nipple 344 seats with the valve seat 353 thereby prohibiting liquid flow. The closed state of the valve assembly is illustrated in FIG. 22A. The open state of the valve assembly 342 is not shown. To limit liquid from unintentionally escaping from the reservoir 338 an seal 352 is positioned on the shoulder 351 of the nipple 344, such that the elastomeric seal closes the interface between the shoulder 351 of the nipple 344 and the valve seat 353. The seal 352 may be an o-ring or a washer, for example, or any other item capable of sealing the interface between the shoulder 351 of the nipple 344 and the valve seat 353.

An opening 340 is formed in the body portion 337 of the hopper assembly 336 to provide adequate clearance for the head or snout of the laboratory animal. The size of the opening 340 may be tailored to suit the size of the animal's head. A sloped wall 348 is positioned at the base of opening 340 to catch any unconsumed liquid. Liquid that is delivered from the valve assembly 342 but not consumed by the animal travels along the sloped wall 348 and pools at the base of the sloped wall 348. Accordingly, the load cell can account for the weight of the liquid pooled at the base of the sloped wall 348. It is in this manner that the weight of the liquid that was actually consumed by the animal can be accurately monitored.

The body portion 337 of the water hopper assembly 336 may be machined, molded, formed or die-cast and formed from any non-toxic material capable of retaining liquid. In this exemplary embodiment, the body portion 337 is injection molded and composed of polycarbonate material. The body portion 337 may be composed of a transparent material so that laboratory personnel can quickly determine the volume of water within the reservoir. Although not shown, the exterior surfaces of the body portion 337 may include graduated indicia corresponding to the liquid level within the reservoir 338.

Referring generally to the figures, exemplary procedures for assembly of the cage device will now be described.

To close the gate mechanism on the cage mount module so that the gate plate lies in a vertical position and is locked:

(1) Grasp the cage mount module in one's left hand. Using one's right hand's thumb and pointer finger, pull out on the knurled knob of the gate locking mechanism and continue to hold it pulled.

(2) Move the gate into the vertical position while pulling on the knob until the cam hits the stop pin. Release the tension on the knob.

(3) The post inserts into the hole in the adapter. Turn the knurled knob until it springs back into the slot and locks.

To open the gate, reverse the foregoing procedure.

To attach the load cell enclosure to the cage mount module:

(1) Grasp the cage mount module with four fingers under the keyhole plate and with your thumb on the spring clip. Press down on the spring clip and hold it down.

(2) Holding the device at an angle of approximately 45 degrees to the cage, with the spring clip at the top and closest to the top of the cage grommet, engage the groove in the spring clip by inserting the rounded aspect of the clip into the opening.

(3) While holding the grove of the clip in and up against the upper edge of the cage grommet, rotate the bottom of the cage mount module until the lower hook lip is above the lower edge of the cage grommet. Release the spring clip by slowly releasing the pressure of your thumb.

(4) Insert the post through the centered hole, passing through the cage mount module's steel plate and into the opening of the strain gauge cell.

(5) Insert the food hopper with the slotted face towards the adapter's opening of the cage mount module.

(6) Open the gate to the feeding position by reversing the instructions provided above for closing the gate.

To remove the module, grasp module as above, depress the spring clip with the thumb, rotate the bottom of the module away from the cage grommet to a 45 degree angle, and lower the hook groove to free its engagement with the upper edge of the cage grommet.

The system for monitoring the intake of food by animals described herein is adapted for use with various electronics hardware components and software modules. For example, the system is configured for use with a remote node, a sensor cable, a network module, a connector block, an input/output module, a remote node serial number, a data collection computer, and a TCP/IP network, for example.

The remote node is optionally an electronics package mounted near the cage rack. A single remote node can monitor up to 32 cages, for example. The remote node continuously measures the weight of the food hoppers. When the weight of a hopper becomes unstable, indicating that an animal is feeding, the remote node records the previous stable weight as the starting weight. As long as the weight is unstable, a meal is considered to be in progress. Once the weight has been stable for the inter-bout interval, the meal is considered to be concluded. Once the meal is concluded, the start and end weights are used to calculate the meal weight and the start and end times are used to determine the meal duration.

A desirable embodiment comprises a single sensor cable connecting a strain gauge cell to the remote node. Other embodiments, such as multiple cables to a strain gauge cell, or a single cable for multiple strain gauge cells, or a wireless connection are also contemplated.

The network module can be provided as a component of the remote node which connects to the network. This is optionally the topmost module and has LEDs labeled A through D in one embodiment. The LED's on the remote node reflect various aspects of the system operation. For example, in an exemplary embodiment, the ‘D’ light indicates that the system is operational. The ‘A’ light indicates message activity between the remote node and a central station. The ‘B’ light blinks whenever a meal is recorded and the ‘C’ light is on whenever stored meals are available for download by the central station. Each remote node can be assigned to one network module.

The connector block is optionally provided as a component of the remote node where the sensor wire(s) are attached. These modules can be removed and inserted without powering down the remote node. The connector block can typically have up to 8 sensors connected to it, or more. There are typically one to four connector blocks in a remote node, and in some cases one to eight or more.

The input/output (I/O) module can be provided as a component of the remote node that converts signals received from the sensors into a form usable by the network module. The I/O modules may be removed and inserted without powering down the remote node. There are typically one to four I/O modules in a remote node, and in some cases up to eight or more. Typically, there are the same number of I/O modules as connector blocks.

The remote node serial number is a unique number assigned to each remote node based on a serial number that may be printed on the side of the network module. The serial number is also utilized in conjunction with a license key that is provided with the system to provide control over the distribution of the application and to various features within the exemplary embodiment. In the exemplary embodiment, the license key is unique to the serial number of the remote node network controller and the application will only function if the license key is correct.

The data collection computer serves as the primary operator interface and permanent data storage location. It may be a laptop or desktop or other form of computer. The TCP/IP network provides communication between the data collection computer and the remote node. Its form can be a (crossover) cable between the remote node and the data collection computer. More complicated networks may involve other parts of an existing computer network, including VPNs and connections to remote sites.

The communications channel between the remote nodes and the central station PC can be any channel that will support TCP/IP. This includes Ethernet (typical facility computer networks) and the internet. The bandwidth required is approximately 3 to 5 kbits/S per remote node. The system also works well over a VPN between facilities. When the communications is disrupted, the remote nodes will continue to monitor and record and will upload their meal data to the computer automatically when communications is restored.

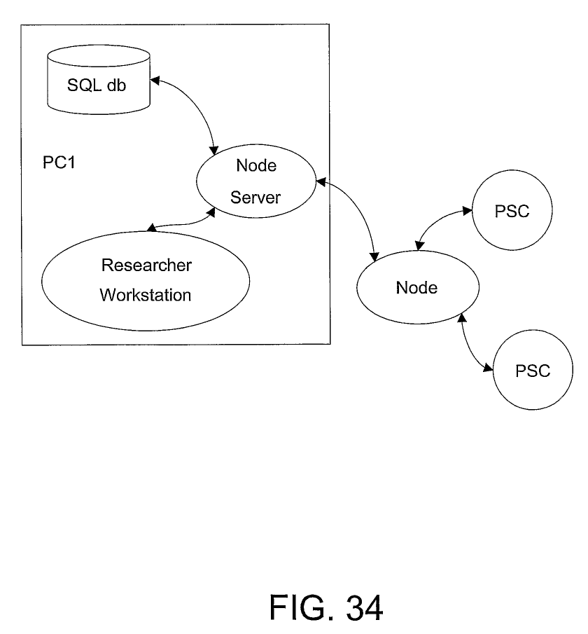

Referring now to FIGS. 34-36, three different exemplary embodiments of systems for monitoring the intake of food by animals are illustrated. In the first exemplary embodiment illustrated in FIG. 34, the Researcher workstation, the Node Server and the Structured Query Language database (SQL db) are integral components of the data collection computer, labeled PC1. One or more Peripheral Control Units (PSC) are connected to or in communication with the Node and the Node is connected to or in communication with the Node Server.

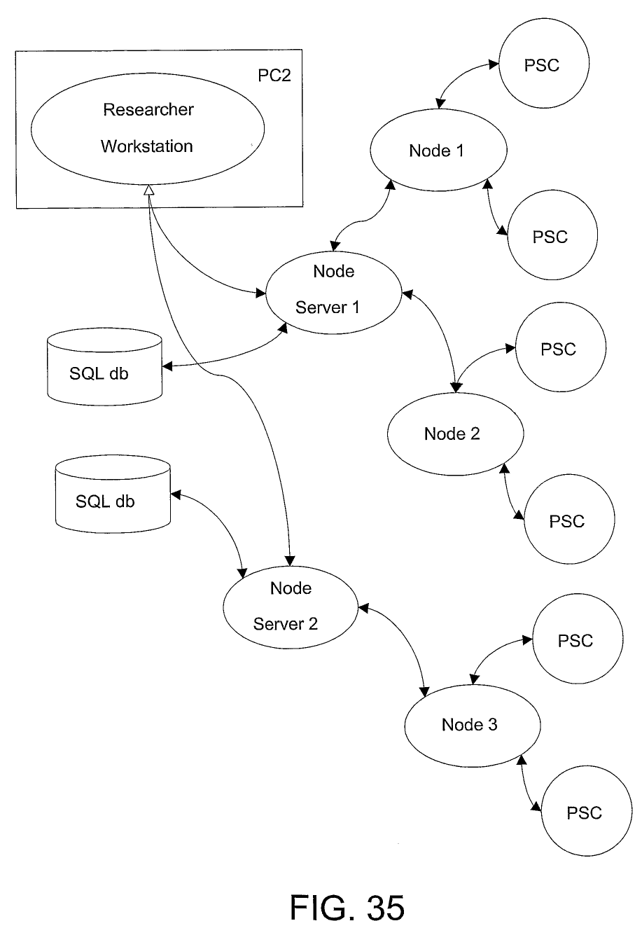

In the second system embodiment illustrated in FIG. 35, the Researcher workstation is an integral component of the data collection computer, labeled PC2. In this embodiment two Node Servers are connected to or in communication with the Researcher Workstation, an SQL database is connected to each Node Server, three Nodes are connected to or in communication with the two Node Servers and multiple PSC's are connected to or in communication with the Nodes. In this embodiment, the user interface function and data gathering functions are split into distinct hardware platforms, thus, the Node Server and the Structured Query Language database (SQL db) are separate from the Researcher Workstation.

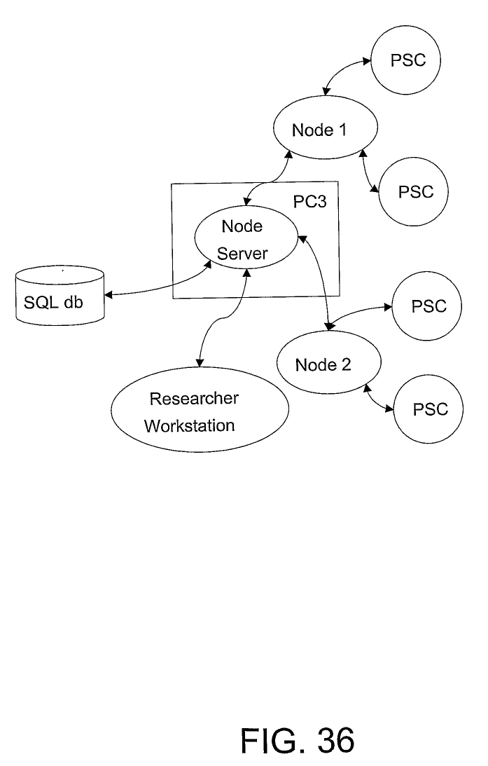

In the third system embodiment illustrated in FIG. 36, the Node Server is an integral component of the data collection computer, labeled PC3. In this embodiment a Researcher Workstation, two Nodes and the SQL database are connected to or in communication with the Node Server, and multiple PSC's are connected to or in communication with the Nodes. Similar to the embodiment illustrated in FIG. 35, the user interface function and data gathering functions are split into distinct hardware platforms, thus, the Researcher Workstation and the SQL db are separate from the Node Server.

With regard to the three systems illustrated in FIGS. 34-36, communications between the data collection computer (i.e. PC1, PC2 and PC3) and the Nodes is TCP/IP, thus, communication may be established over the Internet or Intranet, for example. Furthermore, communications between the Nodes and the PSC units may be short distance analog, digital signaling or TCP/IP.

According to the exemplary embodiment illustrated in FIGS. 20-33, a laboratory animal food consumption analysis and reporting software tool is installed on the data collection computer. The software tool is hereinafter referred to as the BioDAQ software tool or BioDAQ system. The BioDAQ system is configured to record, synthesize and display food consumption data. The functionality of the software tool will be explained with reference to the following figures.

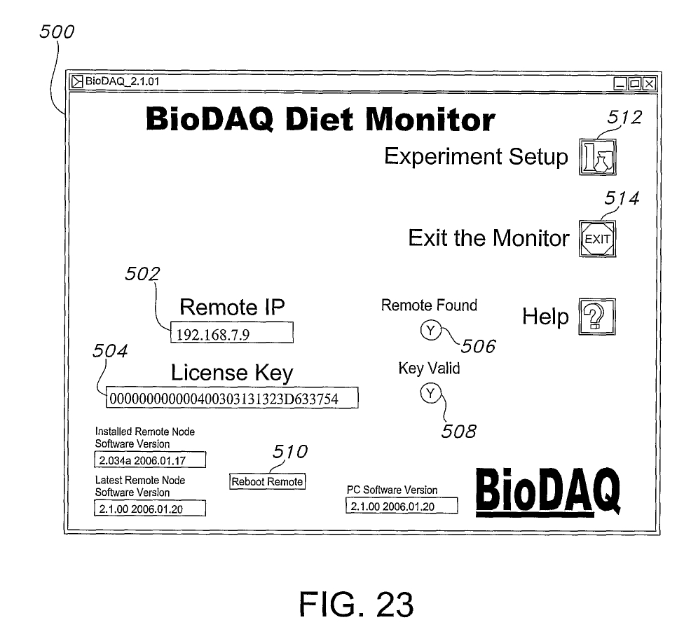

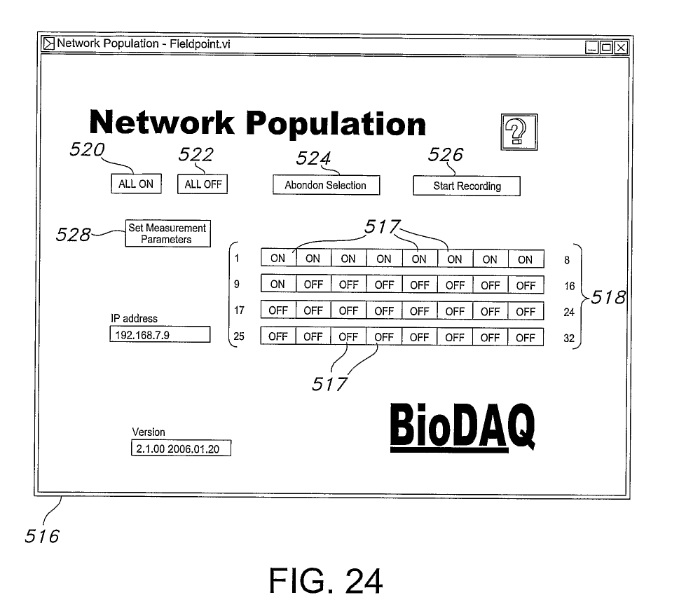

Referring to FIG. 23, a single screen view of an exemplary ‘Startup’ graphical user interface (GUI) 500 of the BioDAQ software tool is illustrated. The Startup GUI 500 is the entrance screen to the software program. The user is prompted to enter the IP address and the license key of the remote node into text boxes 502 and 504, respectively. Once the remote node information has been entered, the GUI 500 alerts the user that the particular remote node has been located by displaying a ‘Y’ (i.e. Yes), as shown, at indicator 506. Similarly, the GUI 500 alerts the user that the license key of the remote node entered into textbox 504 is valid by displaying a ‘Y’ (i.e. Yes), as shown, at indicator 508. If so desired, the user may reboot the remote node by selecting the Reboot Remote icon 510. Once the Remote IP and License Key numbers are entered correctly, the user may proceed to setup the experiment by selecting the Experiment Setup icon 512. Although not shown, after selecting the Experiment Setup icon 512 another GUI appears prompting the user to open an existing experiment or create a new experiment. After an existing experiment is selected or a new experiment is designated, the Network Population GUI 516 shown in FIG. 24 appears. An experiment may be defined as any analysis of the feeding habits of at least one laboratory animal. The user may exit the software program by selecting the Exit icon 514 shown in FIG. 23.

FIG. 24 is a single screen view of an exemplary Network Population GUI 516 of the BioDAQ software tool. In this exemplary embodiment, the experiment optionally includes thirty-two Peripheral Control Units (PSC) releasably attached to animal cages. The PSC's are each connected to or in communication with the remote node. A matrix of thirty-two individual PSC icons 517, hereinafter referred to as the PSC matrix 518, correspond to each of the thirty-two PSC's that are connected to the remote node. As mentioned above, one or more PSC's (also referred to as adapter assemblies 30) may be releasably engaged to an animal cage. It should be understood that the thirty-two PSC icons 517 do not necessarily refer to thirty-two animal cages, rather, the thirty-two PSC icons 517 refer to thirty-two different PSC's that are attached to any number of animal cages. Thus, for example, if thirty-two PSC's are included in the experiment and two PSC's are attached to each animal cage, there are 16 animal cages. Furthermore, each cage is not limited to a single animal, as multiple animals may reside in one cage. However, in a typical experiment, one animal resides in one cage and one PSC is attached to one cage.

The PSC numbers are listed on the left and right side of the cage matrix 518. For example, the top row of individual PSC icons 517 displayed in the PSC matrix 518 denote PSC's 1-8 and the left-most column of individual cage icons 517 denote PSC's 1, 9, 17 and 25 from top to bottom. In this exemplary embodiment, PSC's 1-9 are shown in the ‘ON’ position and PSC's 10-32 are shown in the ‘OFF’ position. The ‘ON’ indicator denotes that the particular PSC will be included in the experiment and the ‘OFF’ indicator denotes that the particular PSC will not be included in the experiment. The status of any PSC may be toggled from ‘ON’ to ‘OFF’ and vice-versa by selecting the respective PSC matrix icon 517. The user may include all of the PSC's in an experiment by selecting the ‘ALL ON’ icon 520. Similarly, the user may exclude all of the PSC's from an experiment by selecting the ‘ALL OFF’ icon 522. The user may return to the ‘Startup’ GUI 500 by selecting the ‘Abandon Selection’ icon 524.

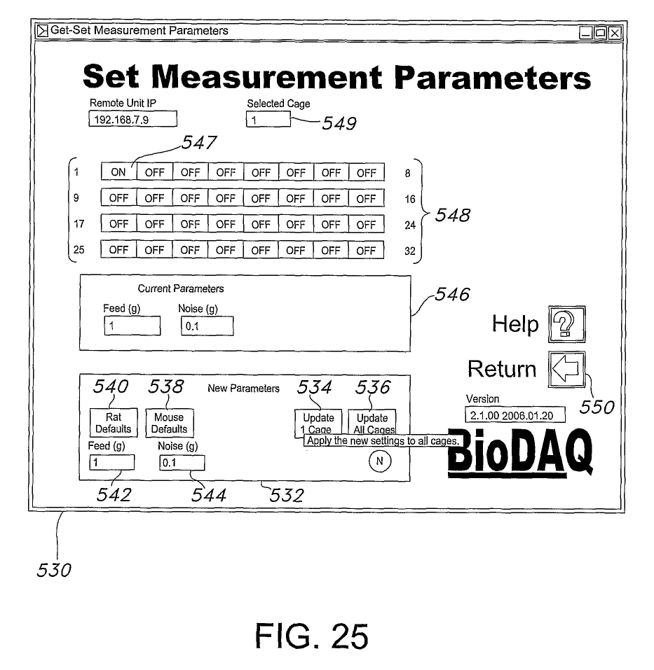

The user may select the ‘Set Measurement Parameters’ icon 528 to define the unique measurement parameters of the experiment. Accordingly, selection of icon 528 launches the Set Measurement Parameters GUI 530 illustrated in FIG. 25.

Referring now to FIG. 25, the measurement parameters of the experiment are established in the ‘New Parameter’ section 532 of the Set Measurement Parameters GUI 530. In this embodiment, the adjustable parameters are ‘Feed’ and ‘Noise’. ‘Feed’ refers to the minimum weight change sensed by the load cell to initiate recordation of a feeding bout. ‘Noise’ refers to the maximum weight change sensed by the load cell to stop recordation of a feeding bout. In this example, when the load cell senses a weight change of 1.0 grams or more, the BioDAQ software tool starts recording a feeding bout. Furthermore, when the load cell senses a weight change of 0.1 grams or less over the course of a feeding bout, the BioDAQ software tool stops recording the feeding bout. The ‘Feed’ and ‘Noise’ parameters may be set for an individual PSC or all of the PSC's.

To set the ‘Feed’ and ‘Noise’ parameters for one particular PSC, for example PSC 1, the individual PSC icon 547 within the PSC matrix 548 is selected. The selected PSC, e.g. PSC 1, is automatically displayed in the ‘Selected Cage’ display 549, as shown. The ‘Feed’ and ‘Noise’ parameters of PSC 1 are then entered into textboxes 542 and 544, respectively. Finally, the ‘Update 1 Cage’ icon 534 is selected to formally set the parameters for the PSC. To set the ‘Feed’ and ‘Noise’ parameters for all of the PSC's, the ‘Feed’ and ‘Noise’ parameters are entered into textboxes 542 and 544, respectively. Next, the ‘Update All Cages’ icon 536 is selected to formally set the parameters for all of the PSC's, e.g. PSC's 1-32.

Multiple default values for both ‘Feed’ and ‘Noise’ may be stored in the BioDAQ system. The default values are uniquely defined by the user of the software. For example, the Feed and Noise parameters for mice may be set to 0.5 g and 0.05 g, respectively, and the Feed and Noise parameters for rats may be set to 1.0 g and 0.5 g, respectively. Thus, if either rats or mice are commonly used in experiments, it is simple for the user to set the appropriate ‘Feed’ and ‘Noise’ values using the default entries. By virtue of the default values, a user of the software tool is not required to manually populate the ‘Feed and Noise’ textboxes 542 and 544 for each PSC. It is envisioned by the inventors that the default value feature may simplify the process of setting measurement parameters and may eliminate the possibility of entering inaccurate information into the ‘Feed and Noise’ textboxes 542 and 544. It should be understood that the default settings are not limited to rats and mice.

To apply a default ‘Feed’ and/or ‘Noise’ value to a PSC, either icon 540 or icon 538 may be selected. Thereafter, either the ‘Update All Cages’ icon 536 is selected to apply the default ‘Feed’ and ‘Noise’ parameters to all of the PSC's, or, alternatively, ‘Update 1 Cage’ icon 534 is selected to apply the default ‘Feed’ and ‘Noise’ parameters to a single PSC. The current stored ‘Feed’ and ‘Noise’ parameters are shown in the ‘Current Parameter’ section 546 of the Set Measurement Parameters GUI 530.

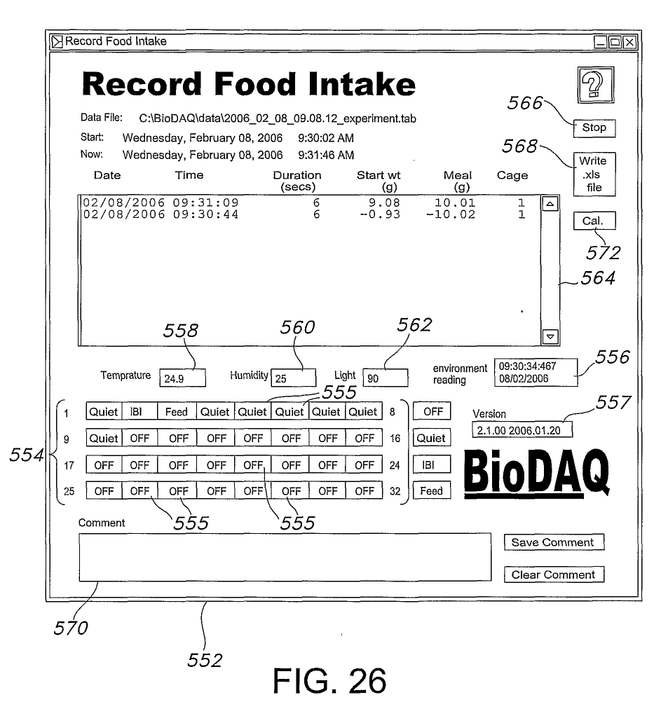

After the measurement parameters are defined in the Set Measurement Parameter GUI 530, the return icon 550 is selected to return the user to the Network Population GUI 516 illustrated in FIG. 24. The user selects the ‘Start Recording’ icon 526 in the Network Population GUI 516 to start the experiment. Although not shown, a reminder message appears to remind the user to open the animal cages gates to permit the animals to feed. Acknowledging the reminder message launches the ‘Record Food Intake’ GUI 552 illustrated in FIG. 26.

Referring now to the ‘Record Food Intake’ GUI 552 illustrated in FIG. 26, the feeding activity data for each PSC connected to the Remote Node is displayed in the PSC activity display matrix 554. Similar to the PSC matrix 518, each PSC icon 555 of the PSC activity display matrix 554 represents an individual PSC. The current state of the feeding activity for each PSC is displayed on PSC icon 555, as shown. In this exemplary embodiment, the BioDAQ system may display the feeding activity status for each PSC to Feed, Quiet, IBI (Inter-Bout Interval), or OFF, as denoted by the Feed, Quiet, IBI, and OFF indicators displayed on PSC icons 3, 1, 2 and 10, respectively.

The ‘Feed’ indicator signifies that the animal is actively feeding and a meal is in progress. The ‘IBI’ indicator signifies that a meal is in progress but the animal is not actively feeding, thus the hopper weight has not been unstable for the inter-bout interval. The ‘Quiet’ indicator denotes that a meal is not in progress and the animal is not actively feeding. The ‘OFF’ indicator signifies that the PSC is not included in the experiment. The different indicators may be color-coded for the purposes of differentiation.

The individual feeding bouts reported by each PSC are recorded and illustrated in the feeding activity display 564 of the ‘Record Food Intake’ GUI 552. Two feeding bouts are shown in the feeding activity display 564 illustrated in FIG. 26. Each feeding bout is displayed along a row of the feeding activity display 564. Referring to the individual columns of the display 564, the PSC number is displayed in the ‘Cage’ column of the feeding activity display 564. The total food consumed during each feeding bout is displayed in the ‘Meal’ column. The starting weight of the food contained within the hopper prior to each feeding bout is displayed in the ‘Start wt.’ column. The duration of each feeding bout is displayed in the ‘Duration’ column. Finally, the time and date of each feeding bout is recorded in the respective ‘Time’ and ‘Date’ columns.

In addition to recording and displaying feeding bout data, the environmental conditions are recorded and displayed in the ‘Record Food Intake’ GUI 552. Specifically, the temperature is shown in display box 558, the humidity is shown in display box 560, the light level (recorded and shown as a percentage) is shown in display box 562 and the approximate time and date of recordation is shown in display box 556 of the ‘Record Food Intake’ GUI 552.

Although not shown, the BioDAQ software is capable of uploading the experiment data to any program capable of generating a spreadsheet, such as Microsoft® Excel. Selecting the ‘Write .xls file’ icon 568 on the ‘Record Food Intake’ GUI 552 automatically generates a spreadsheet. A Comment text box 570 is provided for recording any observations, notes or comments associated with the experiment record. The comments entered into text box 570 are saved along with the experiment records.

Selecting the ‘Stop’ icon 566 stops recording of the experiment. Once the experiment has stopped the system returns to the FIG. 23 ‘Startup’ screen GUI 500.

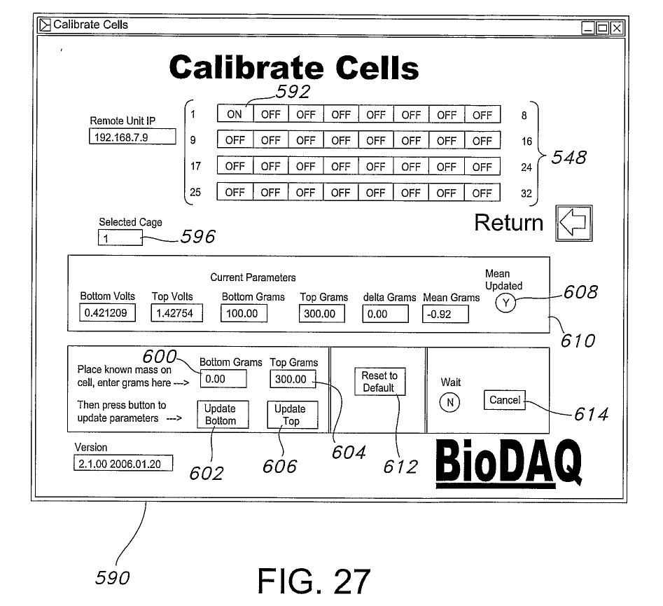

The BioDAQ software tool provides a calibration feature to improve the accuracy of each load cell. More specifically, to calibrate each load cell, the user selects the ‘Cal.’ icon 572 on the ‘Record Food Intake’ GUI 552 to launch the ‘Calibrate Cells’ GUI 590 shown in FIG. 27.

Referring now to FIG. 27, to calibrate a load cell of a PSC, an individual PSC icon 592 within the PSC matrix 594 is selected. In the example illustrated in FIG. 27, the load cell of PSC 1 is selected for calibration. The selected PSC is automatically displayed in the ‘Selected Cage’ display 596, as shown. Thereafter, in practice, the user places a known mass (e.g. 10 g) into the food hopper of PSC 1. The known mass (e.g. 10 g) is entered into the ‘Bottom Grams’ textbox 600. The user then selects the ‘Update Bottom’ icon 602. After the ‘Mean Update’ indicator 608 changes color or displays a message, such as the ‘Y’ illustrated in FIG. 27, the user replaces the first known mass (e.g. 10 g) in the hopper of PSC 1 with a second known mass (e.g. 300 g). The user then selects the ‘Update Top’ icon 606. After the ‘Mean Update’ indicator 608 changes color or displays a message, such as the ‘Y’ illustrated in FIG. 27, the load cell is calibrated. The current parameters of the load cell, such as the load cell voltages corresponding to the two known masses, are displayed in the Current Parameter section 610 of the ‘Calibrate Cells’ GUI 590. A ‘Reset to Default’ icon 612 is provided in the event of an improper entry or an out of sequence calibration. If the ‘Reset to Default’ icon 612 is selected, the load cell is returned to its default calibration value. Moreover, a ‘Cancel’ icon 614 is provided to cancel a pending calibration operation. Any number of load cells may be calibrated in the ‘Calibrate Cells’ GUI 590 following the sequence of steps provided above.

The BioDAQ software tool also provides a measurement assessment feature so that the user may actively and visually observe weight measurements (also referred to as readings) real-time. The measurement assessment feature may be used as a software trouble-shooting tool, as described further below.

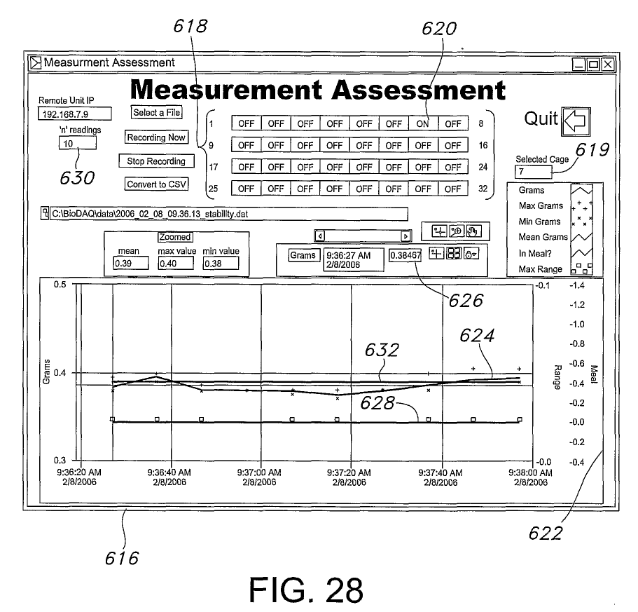

Referring back to FIG. 26, selecting the ‘Version’ icon 557 launches the ‘Measurement Assessment’ GUI 616 shown in FIG. 28. To assess the real-time weight measurements associated with each PSC unit, an individual PSC icon 620 within the PSC matrix 618 is selected by the user. In the example illustrated in FIG. 28, PSC 7 is selected, as shown by the ‘Selected Cage’ display box 619. The weight measurements of PSC 7 are illustrated in a graphical display 622 that displays weight measurement data with respect to time.

In this exemplary embodiment of the BioDAQ system, the weight measurement readings of the selected PSC are transmitted to the BioDAQ software tool approximately once per second. Generally, BioDAQ performs a series of calculations upon every ‘n^{th}’ sequential measurement reading. Each series of ‘n’ sequential measurement readings represents one measurement time interval. The user may define the measurement time interval by entering a numerical value into the ‘n’ readings textbox 630. In this embodiment, ten readings are entered into the ‘n’ readings textbox 630, as shown. Thus, since one measurement reading is transmitted to the BioDAQ software tool every second and ‘n’ is set to ten, the measurement time interval is ten seconds and BioDAQ perform a series of calculations every ten seconds.

The BioDAQ software tool calculates three quantities by means of defined algorithms once every measurement time interval. First, the software tool calculates an average mass of the food within the hopper (referred to as Grams) by averaging the lowest measurement reading of the sequential series (referred to as Min Grams) and the highest measurement reading of the sequential series (referred to as Max Grams). Second, the measurement algorithm calculates a measurement range (referred to as Max Range) by subtracting lowest measurement reading of the sequential series (i.e. Min Grams) from the highest measurement reading of the sequential series (i.e. Max Grams). The third calculation will be described below with reference to the graphical display 622.

Referring still to FIG. 28, the Max Grams, Min Grams, Grams and Max Range values, which were described above, are displayed in the exemplary graphical display 622 once every measurement time interval. The Max Grams data points, which are denoted by ‘+’ symbols, and the Min Grams data points, which are denoted by ‘x’ symbols, represent the maximum and minimum weight measurement readings over each measurement time interval, respectively. A series of Grams data points form the Grams trace 624. The Grams data points represent the numerical average of the Max Grams and the Min Grams data point values. The most-current value of Grams is shown in display box 626. The Max Range data points, which are denoted by ‘□’ symbols, represent the numerical difference between the Max Grams (‘+’ symbols) and the Min Grams data point values (‘x’ symbols). The Max Range may be considered as a gauge of the measurement resolution.

As mentioned above, the BioDAQ software tool calculates three quantities by means of defined algorithms once every measurement time interval, two of which have already been described. The third calculation performed by the BioDAQ software tool once every measurement time interval is referred to as Mean Grams. Mean Grams refers to the mean value of all of the Grams data points displayed on the exemplary graphical display 622. In this example, ten measurement time intervals are illustrated in graphical display 622. Thus, the Mean Grams trace 628 represents the mean value of the Grams data points 624 over ten measurement intervals.

The In Meal trace 628 denotes if the reading was recorded during a meal or if the reading was recorded during a state of inactivity. In this exemplary embodiment, an In Meal trace 628 displayed along the 1.0 hash mark of the Meal axis (i.e. the vertical axis displayed to the right of the graph) denotes that a meal was in progress, and an In Meal trace 628 displayed along the 0.0 hash mark of the Meal axis, as shown in FIG. 28, denotes that a meal was not in progress at the time of the recording.

The BioDAQ software tool continuously compares the computed value of Max Range with the stored values of ‘Feed’ and ‘Noise’ illustrated in FIG. 25 to gauge each PSC's feeding state. In this exemplary embodiment, three PSC feeding states exist, i.e. Feed, IBI and Quiet, which were described above with reference to FIG. 26. First, a condition where the value of Max Range is greater than the Feed value indicates that a meal has started or a meal is in progress for a particular PSC. BioDAQ consequently displays a ‘Feed’ message in the corresponding PSC icon 555 shown in FIG. 26. Second, a condition where the numerical value of Max Range is greater than the Noise value but less than the Feed value indicates that a meal is in progress for a particular PSC. BioDAQ consequently displays an ‘IBI’ message in the corresponding PSC icon 555 shown in FIG. 26. Third, a condition where the numerical value of Max Range is less than the Noise value indicates that a meal has ended and the “inter-bout interval” (IBI) has expired for a particular PSC. BioDAQ consequently displays a ‘Quiet’ message in the corresponding PSC icon 555 shown in FIG. 26.

The measurement assessment feature may be used as a system trouble-shooting tool, i.e., the ‘Record Food Intake’ GUI 552 permits a user to easily compare real-time weight measurement readings with the stored values of Feed and Noise for each PSC.

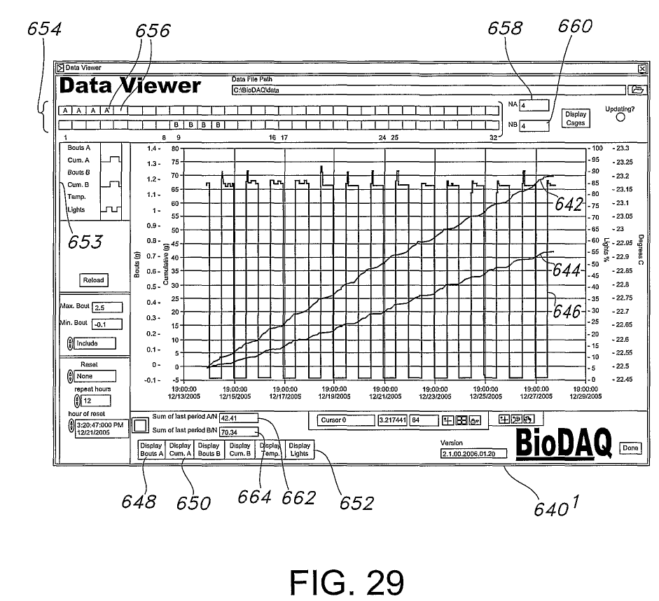

Referring back to FIG. 26, selecting any one of the PSC icons 555 displayed in the ‘Record Food Intake’ GUI 552 launches the ‘Data Viewer’ GUI 640 illustrated in FIGS. 29-33. The ‘Data Viewer’ GUI 640 provides a visual representation of animal feeding activity. The exemplary ‘Data Viewer’ GUI 6401 illustrated in FIG. 29 graphically illustrates the average cumulative feeding habits of two distinct groups of animals, i.e. group A and group B, with respect to time and lighting conditions. For example, group A may represent control mice and group B may represent dosed mice. It is envisioned that it may be useful to display the feeding habits of different animals separately for the purposes of comparison. Moreover, it is also envisioned that it may be useful to display the individual feeding bouts or cumulative feeding habits of animals with respect to lighting conditions, temperature, or any other environmental conditions for the purposes of analysis.

In the exemplary embodiment, the average cumulative food intake of Groups A and B is displayed over approximately 15 days, i.e. from Dec. 14, 2005 to Dec. 28, 2005. The average cumulative food intake of Groups A and B is tracked by traces 642 and 644, respectively, and the status of the lights (i.e. Lights %) is tracked by trace 646. Time is displayed on the horizontal axis of the graph; the lighting condition (i.e. Lights %) is displayed on the right vertical axis of the graph; and the cumulative food intake (i.e. Cumulative (g)) is displayed on the left vertical axis of the graph. Selecting the ‘Display Bouts A’ icon 648 displays trace 642; selecting the ‘Display Bouts B’ icon 650 displays trace 644; and selecting the ‘Display Lights’ icon 652 displays the trace 646. The various traces may have different color, shading or shape, as shown in the trace legend 653. The cumulative food consumption over the 15-day time period for both groups are displayed in the ‘Sum of last period’ display boxes 662 and 664 for Groups A and B, respectively.

In this example, the Lights % is generally set to 85% each day and 0% each night. It can be observed that the animals consume more food at night than the day. Moreover, Group A consumed more food over the 15-day period on average than Group B.

In the exemplary embodiment shown in FIG. 29, feeding data from eight of thirty-two PSC's is displayed in the exemplary ‘Data Viewer’ GUI 640¹. The eight active PSC's are associated with, or members of, either Group A or Group B. It should be understood that one or more animals may be associated with each PSC. Each PSC is represented by two separate PSC icons 656 in a PSC Matrix 654 of the ‘Data Viewer’ GUI 640¹. The top row of PSC icons 656 correspond to Group A and the bottom row of PSC icons 656 correspond to Group B. Selecting an individual PSC icon 656 on the top row denotes that the PSC is associated with Group A and selecting an individual PSC icon 656 on the bottom row denotes that the PSC is associated with Group B, as shown. The name of the group (i.e. A or B) is displayed on the individual PSC icons, as shown. In this example, PSC's 1-4 are members of Group A and PSC's 9-12 are members of Group B. Although not shown, it is conceivable that a PSC may be associated with more than one group. The total number of PSC's associated with each group is displayed in display boxes 658 and 660 on the ‘Data Viewer’ GUI 640¹. The term ‘NA’ adjacent display box 658 refers to the total number of PSC's associated with group A and the term ‘NB’ adjacent display box 660 refers to the total number of PSC's associated with group B.

The BioDAQ software tool calculates the average food consumption of the members of both groups A and B. The average cumulative food consumption of the four members of Group A is represented by trace 642 and the average cumulative food consumption of the four members of Group B is represented by trace 644. It is envisioned that this feature may be useful if the groups comprise a large number of animals (and traces on the graph), which would make it difficult for a user to accurately interpret the graph.

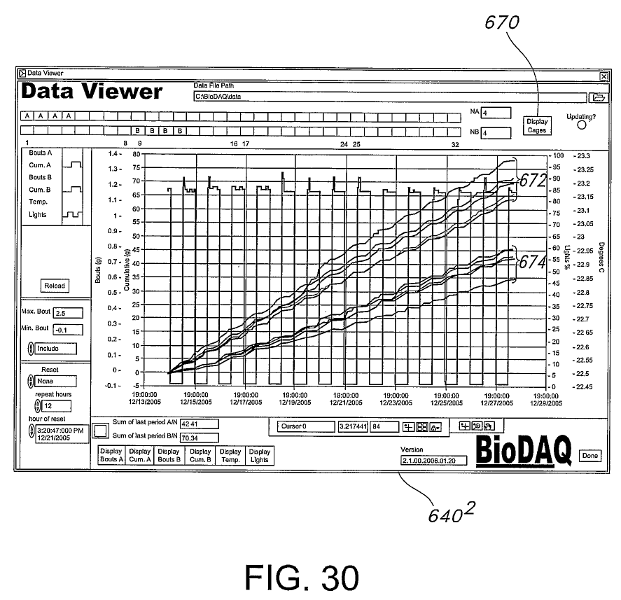

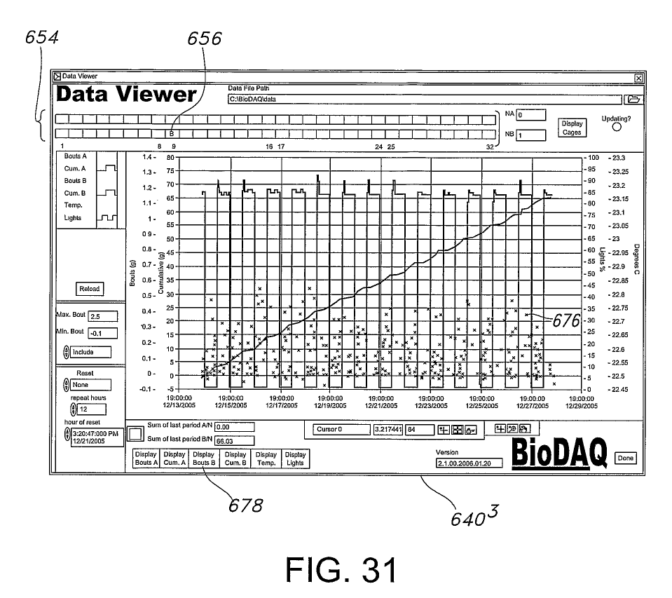

Referring now to the exemplary ‘Data Viewer’ GUI 6402 illustrated in FIG. 30, selecting the ‘Display Cages’ icon 670 displays the cumulative food consumption of the individual members of Group A and B. The four individual traces representing Group A are indicated by trace series 672 and the four individual traces representing Group B are indicated by trace series 674. It is envisioned that this feature may be useful to view the feeding habits of a single animal or a group of animals associated with a single PSC.

Referring now to the exemplary ‘Data Viewer’ GUI 6403 illustrated in FIG. 31, the cumulative food consumption and individual feeding bouts of Group B are illustrated with respect to time and lighting conditions. Selecting the ‘Display Bouts B’ icon 678 displays the individual feeding bout data points, denoted by ‘x’ symbols, which are scattered throughout the graph. In this example, Group B only includes one PSC, i.e. PSC 9, as shown in the PSC matrix 654.

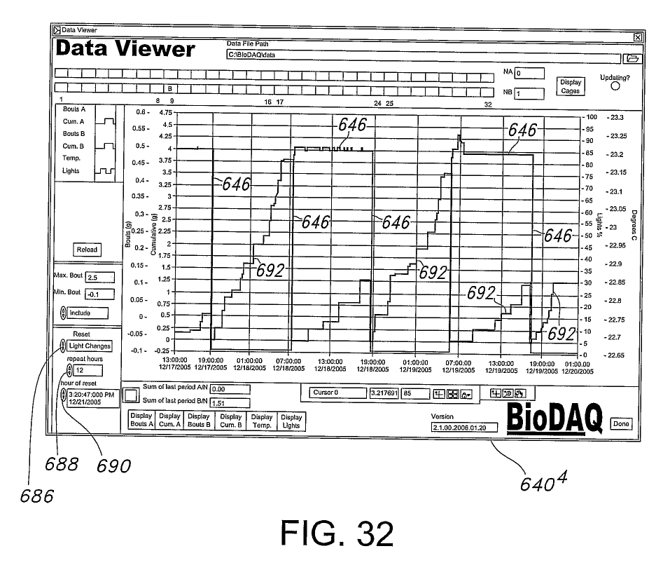

Referring now to the exemplary ‘Data Viewer’ GUI 6404 illustrated in FIG. 32, the cumulative food consumption of Group B is illustrated with respect to time and lighting conditions. However, in this exemplary ‘Data Viewer’ GUI 6404, the cumulative food consumption measurement is reset at each Light % change event over a period of about three days (i.e. from Dec. 17, 2005 to Dec. 20, 2005). The cumulative food consumption measurement trace is designated by trace 692 and the Light % trace is designated by trace 646. In this example, the cumulative consumption trace 692 resets to zero as the Light % trace 646 changes, and, in this example, the cumulative measurement trace 692 is reset to zero at about 7:00 and 19:00 on the dates Dec. 17, 2005-Dec. 20, 2005. This feature may be particularly useful for analyzing the cumulative food consumption for an animal or group of animals with respect to changing environmental conditions. The results of the analysis may provide insight into the habits and health of the animal.

The Reset feature is controlled through the Reset drop down menu 686, shown in FIG. 32. Selecting the ‘Light Changes’ option from the Reset drop down box 686, as shown, resets the cumulative food consumption measurement at each light change, as previously described. Although not shown, the cumulative consumption measurement may be reset if the lights are turned on or off, by selecting those options in the drop-down menu 686. Furthermore, selecting a particular time interval within the ‘repeat hours’ drop-down menu 688 resets the cumulative consumption measurement at specific time intervals and selecting a time within the ‘hour of reset’ drop-down menu 690 resets the cumulative consumption measurement at a specific time.

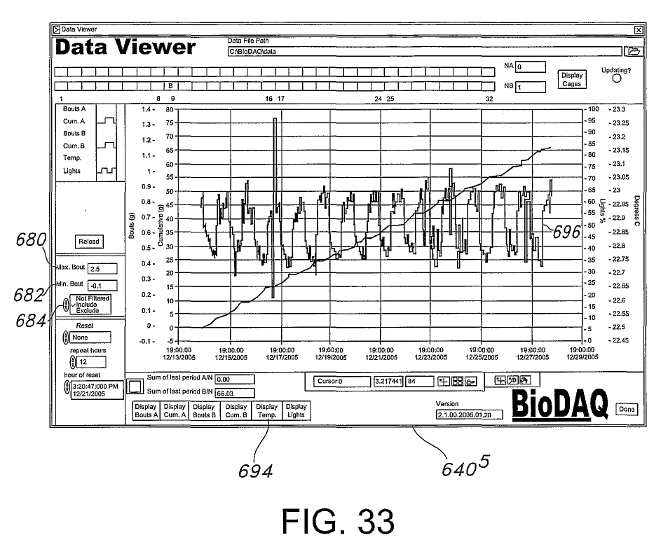

Referring now to the exemplary ‘Data Viewer’ GUI 6405 illustrated in FIG. 33, the cumulative food consumption of Group B is illustrated with respect to time and temperature. Selecting the ‘Display Temp’ icon 694 displays the temperature trace 696 on the graph of the ‘Data Viewer’ GUI 6405. The ‘Display Temp’ tool may be useful to analyze the food consumption with respect to the temperature of the feeding environment. Although only light and temperature data are shown and described herein, other environmental parameters, such as humidity, may be included in the ‘Data Viewer’ GUI.

The BioDAQ software can be configured to disregard erroneous feeding bouts, such as when a PSC is being filled or refilled with food or calibrated by laboratory personnel. This feature of the software tool may be referred to as a bout filter. In particular, the software tool will disregard any feeding bout above the threshold value recorded in the ‘Max. Bout’ text box 680. Similarly, the software tool will disregard any feeding bout below the threshold value recorded in the ‘Min. Bout’ text box 682.

The bout filter is configured through various settings within the drop down menu 684 shown in FIG. 33. By selecting ‘Include’ from the drop down menu 684, as shown, the bout filter disregards feeding bouts above and below the Max. Bout and Min. Bout threshold values, respectively. By selecting ‘Exclude’ from the drop down menu 684, the bout filter only includes feeding bouts above and below the Max. Bout and Min.

Bout threshold values, respectively. The ‘Exclude’ feature may be useful for tracking fill, refill, or calibration events over time. Lastly, selecting ‘Not Filtered’ from the drop down menu 684 deactivates the bout filter, so that the Data Viewer displays every recorded feeding bout. In the exemplary Data Viewer GUI's illustrated in FIGS. 29-33, the bout filter is set to ‘Include’.

Referring now to all of the figures, measuring and evaluating the ingestive behavior of laboratory animals is important in the study of animal behavior, metabolism, and perturbations thereof due to disease or therapeutic intervention. Although numerous advantages are achieved by remotely monitoring the health of animals, the presence of human interaction during the assessment of ingestive behavior may introduce error to the assessment through disturbance to the animal's native behavior by removing the animals from the cages or entering the room where the animals are feeding.

The feeding and monitoring systems described herein bestow several advantages over the existing methods and systems for evaluating the feeding habits of laboratory animals. The animal feeding systems permit the user to measure and evaluate the ingestive behavior without disturbing the animal. Because the exemplary animal feeding systems are entirely automated, less manpower is required to measure and evaluate the ingestive behavior of laboratory animals. The act of feeding and measuring food consumption is also more consistent and repeatable by virtue of the exemplary feeding and monitoring systems.

With regard to the health and safety of the animals, the exemplary feeding systems may be adapted to alert a user when an animal is not feeding properly, as opposed to relying on a human to identify a problem. The notion that a feeding system is capable of alerting a user to a feeding or health problem is founded on the idea that healthy animals generally eat a known quantity of food in a given period. Animals will eat approximately the same mass of food as the water they consume. Thus, if an animal eats ‘x’ grams of food in a twenty-four hour period, it will generally drink about ‘x’ grams of water in the same time period. A number of potential reasons exist to explain why an animal is not eating, such as, for example, the cage gate is closed, food is not available, water is not available, the animal is not acclimated to the food or the hopper, the animal is not hungry because of experiment protocol, or the animal is dead. Remotely monitoring the food intake permits a user to infer the health of the animal based solely on the food intake or food intake in conjunction with water intake.

The exemplary monitoring systems bestow a single centralized monitoring system for the recordation and synthesis of feeding behavior. The lifetime feeding history of an animal may be recorded in the centralized system. Knowledge of the feeding habits and health of an animal over its lifetime may make the animal particularly useful and/or valuable for any variety of reasons.

Although the invention is illustrated and described herein with reference to specific embodiments, the invention is not intended to be limited to the details shown. Rather, various modifications may be made in the details within the scope and range of equivalents of the claims and without departing from the invention.

For example, the feeding mechanism is optionally provided with integrated behavioral paraphernalia such as a press bar, a light, or other stimuli. Also, the feeding mechanism is optionally provided with integrated environmental monitoring for ambient parameters such as in-cage temperature, humidity, light and other parameters. Additionally, the feeding mechanism is optionally provided with an integrated activity monitor, either discrete or by data-mining the feeding load cell.

Additionally, and according to yet another aspect of this invention, the system can be configured to help a user to classify animals based on data retrieved and/or stored by the system. According to one embodiment, for example, the system can be configured to help a user to classify animals based on a few days' data. In one exemplary application, for example, this ability to classify animals based on limited data makes it possible to classify animals as “naturally obese” or “not naturally obese.”

For example, the remote node may optionally be eliminated and the data collection computer optionally communicates directly with the strain gauge cell, via a network, via a wired connection or wireless connection. In addition, another embodiment includes multiple remote nodes utilized with a single data collection computer.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. An animal feeder comprising:
a hopper for storing pieces of food having an opening;
a gate movable with respect to the hopper between an open position rendering the opening of the hopper at least partially accessible to an animal and a closed position at least partially preventing access to the opening of the hopper by an animal; and
a switch coupled to the gate.

2. The animal feeder of claim 1, wherein activation of the switch by an animal signals a motivation of the animal to eat food stored in the hopper.

3. The animal feeder of claim 1, wherein the switch is activated by pushing or pulling of the gate by the animal.

4. The animal feeder of claim 1, the feeder being configured to open the gate after an animal activates the switch by contacting the gate.

5. The animal feeder of claim 4, the feeder being configured to open the gate after an animal contacts the gate a pre-determined number of times.

6. The animal feeder of claim 1, further comprising a cam coupled to the gate and an arm coupled to the switch, wherein the cam moves with respect to the arm.

7. The animal feeder of claim 1, the switch being selected from the group consisting of a vibration sensor an accelerometer, a displacement switch, a light beam switch or other mechanical sensor.

8. An animal feeder comprising:
a hopper; and
a screen coupled to the hopper to retain food within the hopper and provide access by an animal to the food.

9. The animal feeder of claim 8, wherein the screen is positioned at least partially within the hopper in such a way as to contain food within the hopper while permitting access to the food by an animal.

10. The animal feeder of claim 8, further comprising a mesh engaged by a surface of the screen.

11. The animal feeder of claim 10, wherein the mesh is releasably engaged with respect to the screen so that it can be removed and replaced.

12. The animal feeder of claim 10, wherein the mesh is formed from at least one wire.

13. The animal feeder of claim 12, wherein elongated runs of the wire run in a substantially horizontal direction.

14. The animal feeder of claim 12, wherein elongated runs of the wire run in a substantially vertical direction.

15. The animal feeder of claim 12, wherein the wire is rounded or has a circular cross-sectional shape.

16. The animal feeder of claim 8, wherein the screen is metallic.

17. The animal feeder of claim 8, wherein the screen is a one-piece component.

18. The animal feeder of claim 8, wherein the screen includes at least one flange to facilitate interconnection of the screen and a surface of the hopper.

19. The animal feeder of claim 8, wherein the screen comprises a plurality of formed wires coupled to opposing headers.

20. The animal feeder of claim 19, wherein the opposing headers are configured to engage or snap onto the hopper.

21. The animal feeder of claim 8, wherein the screen is shaped to allow an animal access to contained food from at least one of the top, side or bottom of the hopper.

22. The animal feeder of claim 8, wherein the screen defines openings that are larger than an animal muzzle but smaller than pellets of the food.

123. An animal feeder comprising:
a hopper;
a reservoir defined by the hopper for storing a liquid; and
a valve configured to permit selective flow of liquid from the reservoir.

24. The animal feeder of claim 23, further comprising means for transmitting the weight of liquid contained within the hopper.

25. The animal feeder of claim 23, wherein a top end of the reservoir is either open to the atmosphere or covered.

26. The animal feeder of claim 23, wherein the reservoir is defined by a body portion of the hopper.

27. The animal feeder of claim 26, wherein the valve is coupled to the body portion of the hopper.

28. The animal feeder of claim 23, wherein the valve comprises a valve housing and a nipple mounted for movement with respect to the valve housing to permit selective flow of liquid from the reservoir.

29. The animal feeder of claim 28, wherein the nipple is spring loaded.

30. The animal feeder of claim 28, further comprising a seal positioned to provide a selective seal between the nipple and the valve housing.

31. The animal feeder of claim 30, wherein the seal closes an interface between the nipple and the valve housing in a closed position of the valve.

32. The animal feeder of claim 26, wherein a recess is defined in the body portion of the hopper to provide at least partial clearance for the head of the laboratory animal.

33. The animal feeder of claim 32, the recess comprising a sloped wall disposed to capture unconsumed liquid released from the reservoir.

34. An animal feeder comprising:
a hopper having an opening and an interior for storing pieces of food;
a gate movable with respect to the hopper between an open position rendering the opening of the hopper at least partially accessible to an animal and a closed position at least partially preventing access to the opening by an animal, the gate being pivotable to rotate between the open and closed positions.

35. The animal feeder of claim 34, further comprising a cam coupled to the gate.

36. The animal feeder of claim 35, further comprising an arm connected to a servo, wherein the cam moves with respect to the arm.

37. The animal feeder of claim 36, wherein the cam is mechanically grounded against the arm in the closed position of the gate.

38. The animal feeder of claim 36, wherein the servo is configured to be deactivated in one or more positions of the gate.

39. The animal feeder of claim 34, wherein the gate is configured to be captured in a pre-selected position.

40. The animal feeder of claim 39, further comprising a surface associated with the cam or the gate to capture the gate in a pre-selected position.

41. The animal feeder of claim 34, wherein the gate is biased toward a desired position under the force of gravity.

42. The animal feeder of claim 34, wherein the gate is pivotable about a shaft to rotate between the open and closed positions.

43. A method of communicating feeding activity of an animal, the method comprising the steps of:
storing data corresponding to individual feeding bouts; and
displaying the individual feeding bouts.

44. The method of claim 43, the displaying step comprising displaying the individual feeding bouts in a graphical user interface (GUI).

45. The method of claim 43 further comprising the step of storing data corresponding to a cumulative feeding bout.

46. The method of claim 45 further comprising the step of storing cumulative feeding bout data of at least one group of animals, wherein at least one animal is a member of a group of animals.

47. The method of claim 46 further comprising the step of calculating an average cumulative feeding bout of a group of animals.

48. The method of claim 47 further comprising the step of displaying the average cumulative feeding bout of a group of animals.

49. The method of claim 45 further comprising the step of resetting the cumulative feeding bout measurement to a pre-determined value in the event of a change in an environmental condition.

50. The method of claim 45 further comprising the step of resetting the cumulative feeding bout measurement to a pre-determined value after a pre-determined time interval.

51. The method of claim 45 further comprising the step of displaying the cumulative feeding bout.

52. The method of claim 43 further comprising the steps of displaying the individual feeding bouts and displaying an environmental condition with respect to time.

53. The method of claim 43 further comprising the step of filtering individual feeding bout data in a specified data range.

54. The method of claim 53 further comprising the step of displaying the individual feeding bout within the specified data range.

55. The method of claim 53 further comprising the step of displaying the individual feeding bout outside of the specified data range.

56. A method of monitoring feeding activity of an animal, the method comprising the steps of:
communicating data corresponding to individual feeding bouts to a remote location; and
displaying the individual feeding bouts at the remote location.

57. The method of claim 56 further comprising the step of communicating data corresponding to individual feeding bouts of multiple animals to a remote location.

58. The method of claim 56 further comprising the step of communicating the data over a network.

59. The animal feeder of claim 38, wherein the servo and gate are configured to be maintained in one or more positions of the gate when the servo is deactivated.

60. A method of monitoring the health of an animal, the method comprising the steps of:
collecting data corresponding to the feeding activity of the animal; and
receiving the data at a remote location.

61. The method of claim 60, wherein the recording step does not involve human interaction with or direct observation of the animals.

62. The method of claim 60, said receiving step comprising receiving a signal via an audible, visual, e-mail, pager, or other signaling mechanism that an animal is unhealthy.
